(19) United States
(12) Patent Application Publication
(10) Pub. No.: US 2012/0197693 A1
(43) Pub. Date: Aug. 2, 2012

(54) ELECTRICITY TRANSFER SYSTEM NETWORK AND RELATED METHODS

(75) Inventors: Donald B. Karner, Phoenix, AZ (US); Robert Page, Phoenix, AZ (US); Garrett Beauregard, Phoenix, AZ (US); Colin Read, San Francisco, CA (US); Gregory P. Fioriti, Scottsdale, AZ (US); Cecil H. Broadnax, III, Phoenix, AZ (US); Carmelo A. Carpinteri, Phoenix, AZ (US); Andrew W. Hooper, San Francisco, CA (US); Cynthia M. Gomez, Tucson, AZ (US)

(73) Assignee: Electric Transportation Engineering Corporation d/b/a ECOtality North America, Phoenix, AZ (US)

(21) Appl. No.: 13/398,675

(22) Filed: Feb. 16, 2012

Related U.S. Application Data
(63) Continuation-in-part of application No. PCT/US2011/034667, filed on Apr. 29, 2011.
Application No. PCT/US2011/034667 is a continuation-in-part of application No. PCT/US2011/037590, filed on May 23, 2011.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.

(51) Int. Cl. G06Q 20/14; G06Q 30/02

(52) U.S. Cl. 705/14.1; 705/40

(57) ABSTRACT

Some embodiments include an electricity transfer system network. Other embodiments of related systems and methods are also disclosed.

### CROSS-REFERENCE TO RELATED APPLICATIONS

This application is a continuation-in-part of International Patent Application Serial No. PCT/US2011/034667, filed Apr. 29, 2011. International Patent Application Serial No. PCT/US2011/034667 claims the benefit of: (1) U.S. Provisional Application Ser. No. 61/367,316, filed Jul. 23, 2010; (2) U.S. Provisional Application Ser. No. 61/367,321, filed Jul. 23, 2010; (3) U.S. Provisional Application Ser. No. 61/367,337, filed Jul. 23, 2010; and (4) U.S. Provisional Application Ser. No. 61/367,317, filed Jul. 23, 2010.

This application is also a continuation-in-part of International Patent Application Serial No. PCT/US2011/037590, filed May 23, 2011. International Patent Application Serial No. PCT/US2011/37590 claims the benefit of: (1) U.S. Provisional Application Ser. No. 61/367,316; (2) U.S. Provisional Application Ser. No. 61/367,321; (3) U.S. Provisional Application Ser. No. 61/367,337; (4) U.S. Provisional Application Ser. No. 61/367,317; and (5) International Patent Application Serial No. PCT/US2011/034667. Meanwhile, International Patent Application Serial No. PCT/US2011/034667 claims the benefit of: (1) U.S. Provisional Application Ser. No. 61/367,316; (2) U.S. Provisional Application Ser. No. 61/367,321; (3) U.S. Provisional Application Ser. No. 61/367,337; and (4) U.S. Provisional Application No. 61/367,317.

International Patent Application Serial No. PCT/US2011/037590, International Patent Application Serial No. PCT/US2011/034667, U.S. Provisional Application Ser. No. 61/367,316, U.S. Provisional Application Ser. No. 61/367,321, U.S. Provisional Application Ser. No. 61/367,337, and U.S. Provisional Application Ser. No. 61/367,317 are incorporated herein by reference in their entirety.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to electricity transfer system networks, and relates more particularly to such electricity transfer system networks that promote and encourage use of electric vehicles and related methods.

### DESCRIPTION OF THE BACKGROUND

Many potential users of electric vehicles have not yet embraced electric vehicle technologies out of anxiety over adjusting from more familiar internal combustion vehicle technologies and systems and methods for refueling the same. Accordingly, a need or potential for benefit exists for an electricity transfer system network that encourages and/or promotes use of electric vehicles by facilitating, simplifying, and/or standardizing electricity transfer systems and methods for providing electricity to electric vehicles.

### BRIEF DESCRIPTION OF THE DRAWINGS

To facilitate further description of the embodiments, the following drawings are provided in which:

FIG. 1 illustrates an electricity transfer system network (ETSN), according to an embodiment;

FIG. 2 illustrates a flow chart for an embodiment of a method of operating an electricity transfer system network (ETSN) computer system of an electricity transfer system network (ETSN) and/or an application programmable interface (API) related thereto;

FIG. 3 illustrates an exemplary procedure of receiving payment from and/or billing a user for use of an electricity transfer system according to a pay-per-transaction payment scheme if the user uses the electricity transfer system in a guest user capacity, according to the embodiment of FIG. 2;

FIG. 4 illustrates an exemplary procedure of receiving payment from and/or billing a user for use of an electricity transfer system according to a pay-per-period payment scheme if the user uses the electricity transfer system in a basic member user capacity and/or a premium member user capacity, according to the embodiment of FIG. 2;

FIG. 5 illustrates a flow chart for an embodiment of another method of operating an electricity transfer system network (ETSN) computer system of an electricity transfer system network (ETSN) and/or an application programmable interface (API) related thereto;

FIG. 6 illustrates an exemplary procedure of receiving a request from an electricity transfer system indicating that the user is using the electricity transfer system in one of two or more user capacities, according to the embodiment of FIG. 5;

FIG. 7 illustrates an exemplary procedure of charging and/or billing a user for use of the electricity transfer system according to one of two or more user fee structures corresponding to two or more user capacities respectively, according to the embodiment of FIG. 5;

FIG. 8 illustrates a flow chart for an embodiment of another method of operating an electricity transfer system network (ETSN) computer system of an electricity transfer system network (ETSN) and/or an application programmable interface (API) related thereto;

FIG. 9 illustrates an exemplary procedure of incentivizing a host to affiliate with the electricity transfer system network, according to the embodiment of FIG. 8;

FIG. 10 illustrates a flow chart for an embodiment of another method of operating an electricity transfer system network (ETSN) computer system of an electricity transfer system network (ETSN) and/or an application programmable interface (API) related thereto;

FIG. 11 illustrates an exemplary procedure of incentivizing a user to use an electricity transfer system in a basic member capacity and/or a premium member capacity;

FIG. 12 illustrates a computer system that is suitable for implementing an embodiment of an electricity transfer system network computer system and/or an electricity transfer system computer system; and

FIG. 13 illustrates a representative block diagram of exemplary components and/or circuitry included in exemplary circuit boards inside a chassis of the computer system of FIG. 12.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “real time” is defined with respect to operations carried out as soon as practically possible upon occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

### DETAILED DESCRIPTION OF EXAMPLES OF EMBODIMENTS

Some embodiments include an electricity transfer system network. The electricity transfer system network is configured to be operated by an electricity transfer system network operator. The electricity transfer system network comprises multiple electricity transfer systems. The electricity transfer system network can be configured such that the user is able to use each of the multiple electricity transfer systems in two or more user capacities, and the two or more user capacities can comprise at least two of a guest user capacity, a first-tier member user capacity, a second-tier member user capacity, or a free user capacity. Furthermore, the electricity transfer system network operator can bill the user for the user's use of the multiple electricity transfer systems according to two or more payment schemes, and the two or more payment schemes can comprise at least two of a pay-per-transaction payment scheme, a pay-per-period payment scheme, or a non-payment payment scheme. When the user uses the multiple electricity transfer systems in the guest user capacity, the electricity transfer system network operator can be paid by the user according to the pay-per-transaction payment scheme. Likewise, when the user uses the multiple electricity transfer systems in either of the basic member capacity or the premium member capacity, the electricity transfer system network operator can be paid by the user according to the pay-per-period payment scheme. Further, when the user uses the multiple electricity transfer systems in the free user capacity, the electricity transfer system operator can be paid by the user according to the non-payment payment scheme.

Various embodiments include a method of operating an electricity transfer system network computer of an electricity transfer system network system and/or an application programmable interface related thereto. As an example, at least part of the method can be implemented via execution of computer instructions configured to run at one or more processing modules and configured to be stored at one or more memory storage modules of at least one of the electricity transfer system network computer system or one or more cloud computers. The method can comprise: executing one or more first computer instructions configured to communicate with an electricity transfer system of electricity transfer systems affiliated with the electricity transfer system network to permit a user of the electricity transfer system network to use the electricity transfer system to transfer electricity from the electricity transfer system to a rechargeable energy storage system of an electric vehicle of the user; executing one or more second computer instructions configured to receive a signal from the electricity transfer system indicating that the user is using the electricity transfer system in one of two or more user capacities, the two or more user capacities comprising at least two of a guest user capacity, a first-tier member user capacity, or a second-tier member user capacity; executing one or more third computer instructions configured to bill the user for using the electricity transfer system according to a pay-per-transaction payment scheme if the user uses the electricity transfer system in the guest user capacity; and executing one or more fourth computer instructions configured to bill the user for using the electricity transfer system according to a pay-per-period payment scheme if the user uses the electricity transfer system in either of the first-tier member user capacity or the second-tier member user capacity. The computer instructions can comprise the one or more first, second, third, and fourth computer instructions.

Further embodiments include an electricity transfer system network. The electricity transfer system network can be configured to be operated by an electricity transfer system network operator. The electricity transfer system network comprises an electricity transfer system. The electricity transfer system is configured to permit a user of the electricity transfer system network to use the electricity transfer system to transfer electricity from the electricity transfer system to a rechargeable energy storage system of an electric vehicle of the user. The electricity transfer system network can be organized such that the user is able to use the electricity transfer system in two or more user capacities, and the two or more user capacities can comprise at least two of a guest user capacity, a first-tier member user capacity, a second-tier member user capacity, or a free user capacity. Meanwhile, the electricity transfer system network operator can bill the user for use of the electricity transfer system according to two or more user fee structures corresponding to the two or more user capacities respectively, and the two or more user fee structures can comprise at least two of a guest user fee structure, a first-tier member user fee structure, a second-tier member user fee structure, or a free user fee structure.

Other embodiments include a method of operating an electricity transfer system network computer system of an electricity transfer system network and/or an application programmable interface related thereto. As an example, at least part of the method can be implemented via execution of computer instructions configured to run at one or more processing modules and configured to be stored at one or more memory storage modules of at least one of the electricity transfer system network computer system or one or more cloud computers. The method can comprise: executing one or more first computer instructions configured to communicate with an electricity transfer system configured to permit a user of the electricity transfer system network to use the electricity transfer system to transfer electricity from the electricity transfer system to a rechargeable energy storage system of an electric vehicle of the user; executing one or more second computer instructions configured to receive a signal from the electricity transfer system indicating that the user is using the electricity transfer system in one of two or more user capacities, the two or more user capacities comprising at least two of a guest user capacity, a first-tier member user capacity, or a second-tier member user capacity; and executing one or more third computer instructions configured to bill the user for use of the electricity transfer system according to one of two or more user fee structures corresponding to the two or more user capacities respectively, the two or more user fee structures comprising at least two of a guest user fee structure, a first-tier member user fee structure, or a second-tier member user fee structure. The computer instructions can comprise the one or more first, second, and third computer instructions, and the electricity transfer system network comprises the electricity transfer system.

Meanwhile, some embodiments include an electricity transfer system network. The electricity transfer system network can be configured to be operated by an electricity transfer system network operator. The electricity transfer system network comprises an electricity transfer system of a host. The electricity transfer system is configured to permit a user of the electricity transfer system network to use the electricity transfer system to transfer electricity from the electricity transfer system to a rechargeable energy storage system of an electric vehicle of the user. Meanwhile, the host can be affiliated with the electricity transfer system network and is separate from the electric transfer system network operator. The electricity transfer system network can be organized such that the user is able to use the electricity transfer system in two or more user capacities, and the two or more user capacities can comprise at least two of a guest user capacity, a first-tier member user capacity, or a second-tier member user capacity. Furthermore, the electricity transfer system network operator can provide one or more host incentives to the host in exchange for being affiliated with the electricity transfer system network.

Likewise, various embodiments include a method of operating an electricity transfer system network computer system of an electricity transfer system network and/or an application programmable interface related thereto. As an example, at least part of the method can be implemented via execution of computer instructions configured to run at one or more processing modules and configured to be stored at one or more memory storage modules of at least one of the electricity transfer system network computer system or one or more cloud computers. The method can comprise: executing one or more first computer instructions configured to communicate with an electricity transfer system of a host, the electricity transfer system being configured to permit a user of the electricity transfer system network to use the electricity transfer system to transfer electricity from the electricity transfer system to a rechargeable energy storage system of an electric vehicle of the user and the host being affiliated with the electricity transfer system network; executing one or more second computer instructions configured to receive a signal from the electricity transfer system indicating that the user is using the electricity transfer system in one of two or more user capacities, the two or more user capacities comprising at least two of a guest user capacity, a first-tier member user capacity, or a second-tier member user capacity; and executing one or more third computer instructions configured to incentivize the host to affiliate with the electricity transfer system network. The computer instructions can comprise the one or more first, second, and third computer instructions.

Still further embodiments include an electricity transfer system network. The electricity transfer system network can be configured to be operated by an electricity transfer system network operator. The electricity transfer system network comprises an electricity transfer system. The electricity transfer system can be configured to permit a user of the electricity transfer system network to use the electricity transfer system to transfer electricity from the electricity transfer system to a rechargeable energy storage system of an electric vehicle of the user. The electricity transfer system network can be organized such that the user is able to use the electricity transfer system in two or more user capacities, and the two or more user capacities comprise at least two of a guest user capacity, a first-tier member user capacity, or a second-tier member user capacity. Furthermore, the electricity transfer system network operator can provide one or more member incentives to the user in exchange for using the electricity transfer system in at least one of the first-tier member user capacity or the second-tier member user capacity.

Still other embodiments include a method of operating an electricity transfer system network computer system of an electricity transfer system network and/or an application programmable interface related thereto. As an example, at least part of the method can be implemented via execution of computer instructions configured to run at one or more processing modules and configured to be stored at one or more memory storage modules of at least one of the electricity transfer system network computer system or one or more cloud computers. The method can comprise: executing one or more first computer instructions configured to communicate with an electricity transfer system of a host, the electricity transfer system being configured to permit a user of the electricity transfer system network to use the electricity transfer system to transfer electricity from the electricity transfer system to a rechargeable energy storage system of an electric vehicle of the user and the host being affiliated with the electricity transfer system network; executing one or more second computer instructions configured to receive a request from the electricity transfer system indicating that the user is using the electricity transfer system in one of two or more user capacities, the two or more user capacities comprising at least two of a guest user capacity, a first-tier member user capacity, or a second-tier member user capacity; and executing one or more third computer instructions configured to incentivize the user to use the electricity transfer system in at least one of the first-tier member capacity or the second-tier member capacity. The computer instructions comprise the one or more first, second, and third computer instructions.

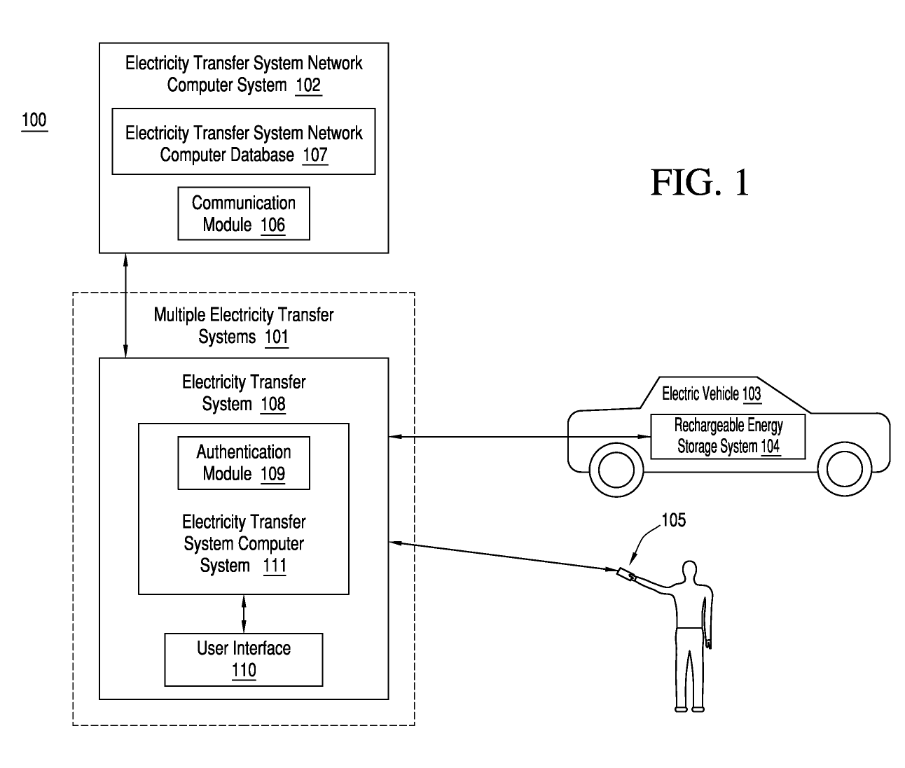

Turning to the drawings, FIG. 1 illustrates electricity transfer system network (ETSN) 100, according to an embodiment. ETSN 100 is merely exemplary and is not limited to the embodiments presented herein. ETSN 100 can be employed in many different embodiments or examples not specifically depicted or described herein.

ETSN 100 comprises multiple electricity transfer systems 101 (e.g., electricity transfer system 108). In many embodiments, ETSN 100 can comprise electricity transfer system network (ETSN) computer system 102 and/or an electricity transfer system network (ETSN) application programmable interface (API) (as described below). In further embodiments, the ETSN application programmable interface can be separate from ETSN 100. In some embodiments, ETSN 100 can comprise electric vehicle 103 and/or rechargeable energy storage system 104 of electric vehicle 103. In further embodiments, ETSN 100 can comprise authentication mechanism 105, communication module 106, and/or electricity transfer system network (ETSN) computer database 107. In many embodiments, ETSN 100 and/or ETSN computer system 102 can comprise communication module 106 and/or ETSN computer database 107. In some embodiments, ETSN computer system 102 can comprise the ETSN application programmable interface while in other embodiments, the ETSN application programmable interface can be separate from ETSN computer system 102. Electricity transfer system 108 can comprise authentication module 109, user interface 110, and/or electricity transfer system (ETS) computer system 111. Each electricity transfer system 108 can be configured to communicate with other electricity transfer systems within multiple electricity transfer systems 101, via communication module 106. In some examples, ETS computer system 111 can comprise authentication module 109.

ETSN 100 can refer to a community of electricity transfer systems that comprises multiple electricity transfer systems 101 and that is administrated over and/or operated by an electricity transfer system network (ETSN) operator. The ETSN operator can use ETSN computer system 102 to administrate and/or operate ETSN 100. In these or other embodiments, the ETSN operator can administrate and/or operate ETSN 100 via an application programmable interface (e.g., via cloud computing) related to ETSN 100, such as, for example, the electricity transfer system network (ETSN) application programmable interface. As an example, the ETSN application programmable interface can communicate with ETSN computer system 102 (e.g., via communication module 106), one or more cloud computer systems, one or more third-party resource computer systems, one or more host computer systems and/or one or more personal computer systems. Accordingly, in these examples, some or all of the functionality of ETSN 100 can be provided by ETSN computer system 102, the cloud computer system(s), the third-party resource computer system(s), the host computer system(s), and/or the personal computer system(s). In a more detailed example, the ETSN application programmable interface can be operated (e.g., in the capacity of an interface only) at one or more processors and/or stored at one or more memory storage modules of ETSN computer system 102 while the remaining functional aspects of ETSN computer system 102, as described herein, are operable at one or more processors and/or storable at one or more memory storage modules of the cloud computer system(s), the third-party resource computer system(s), the host computer system(s), and/or the personal computer system(s). For convenience of illustration, ETSN 100 is generally described with respect to ETSN computer system 102 only, but each of the cloud computer system(s) described above with respect to the ETSN application programmable interface can be similar or identical to ETSN computer system 102, and can be implemented instead of and/or in addition to ETSN computer system 102. Further, any of the functionality described below with respect to ETSN computer system 102 can be implemented by the ETSN application programmable interface and/or the cloud computer system(s).

In further embodiments, similar to the relationship of ETSN computer system 102 and the cloud computer system(s), the third-party resource computer system(s) can be implemented alternatively (and/or additionally) as third-party resource application programmable interface(s) (API('s)) and third-party resource cloud computer system(s); the host computer system(s) can be implemented alternatively (and/or additionally) as host application programmable interface(s) (API('s)) and host cloud computer system(s); and the personal computer system(s) can be implemented alternatively (and/or additionally) as personal application programmable interface(s) (API('s)) and personal cloud computer system(s). In these embodiments, the cloud computer system(s) of the ETSN application programmable interface can comprise the host cloud computer system(s) and/or the personal cloud computer system(s), and/or vice versa. Further, the third-party resource application programmable interface(s) can be operated and/or stored (e.g., self-contained) at the third-party resource computer system(s), the host application programmable interface(s) can be operated and/or stored (e.g., self-contained) at the host computer system(s); and/or the personal application programmable interface(s) can be operated and/or stored (e.g., self-contained) at the personal computer system(s). Moreover, the third-party resource application programmable interface(s) and/or the third-party resource cloud computer system(s) can provide some or all of the functionality (e.g., communication with ETSN computer system 102) of the third-party resource computer system(s); the host application programmable interface(s) and/or the host cloud computer system(s) can provide some or all of the functionality (e.g., communication with ETSN computer system 102) of the host computer system(s); and/or the personal application programmable interface(s) and/or the personal cloud computer system(s) can provide some or all of the functionality (e.g., communication with ETSN computer system 102) of the personal computer system(s).

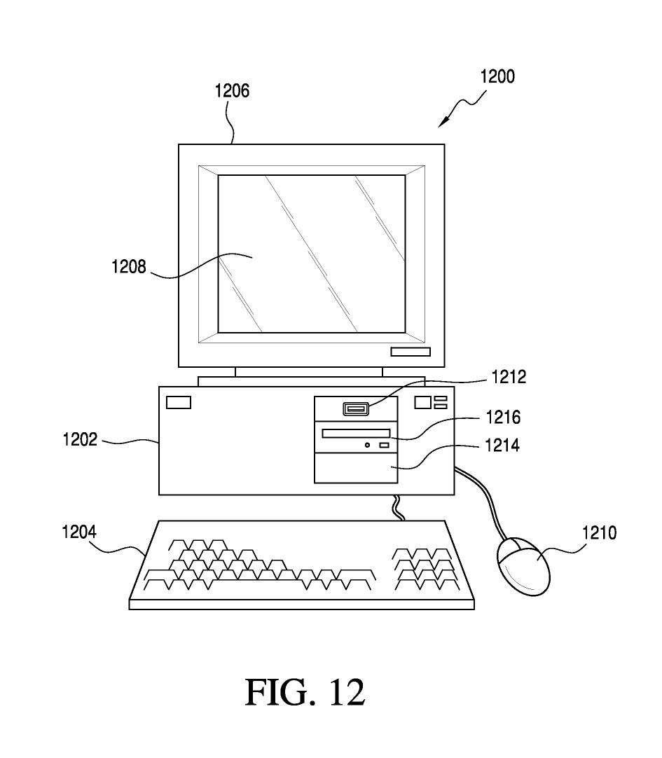

Notwithstanding whether the ETSN operator administrates and/or operates ETSN 100 with ETSN computer system 102, the application programmable interface, or both, the ETSN operator can provide support and/or services (e.g., centrally, remotely, and/or in real-time) to any user(s) of ETSN 100 (e.g., in exchange for compensation of some form). For example, ETSN 100 can leverage computer storage (e.g., data aggregation) and/or processing (e.g., electricity transfer optimization schemes), such as, for example, at ETSN computer system 102 and/or the cloud computer system(s). Further, ETSN 100 can leverage communication with the third-party resource computer system(s) of one or more third-party resources (e.g., financial institution(s), utility company/companies, advertiser(s), electric vehicle original-equipment-manufacturer(s), other electricity transfer system network operator(s), mobile telephone operator(s), electricity transfer system host(s), government entity/entities, etc.), communication and/or networking between the users of ETSN 100 and/or the electricity transfer systems of ETSN 100 (e.g., multiple electricity transfer systems 101), etc. to provide such support and/or services, as will be described in greater detail herein. In any event, the ETSN operator can operate as a for-profit or a not-for-profit entity, as desirable. Accordingly, ETSN 100 can be implemented to generate profit for the ETSN operator, to promote and/or encourage electric vehicle use, and/or to facilitate electric vehicle charging. Further, each of the third-party resource computer system(s) can be similar or identical to computer system 1200 (FIG. 12).

As a preliminary matter, although multiple electricity transfer systems 101 refer generally to commercially available electricity transfer systems, as described in greater detail below, ETSN 100 can also comprise any number of private electricity transfer systems, any one of which can be similar or identical to any electricity transfer system (e.g., electricity transfer system 108) of multiple electricity transfer systems 101. Accordingly, where applicable, any or all of the functionality of ETSN 100 associated with multiple electricity transfer systems 101, as described herein, can be applied and/or be modified to be applied to one or more private electricity transfer systems of ETSN 100.

Thus, having established these various implementations, ETSN computer system 102 can be similar or identical to computer system 1200 (FIG. 12), as described below. Meanwhile, ETSN computer database 107 can comprise one or more computer databases configured (a) to support ETSN 100, ETSN computer system 102, and/or the ETSN operator in terms of data (e.g., usage data, third-party data, member user account/profile data, etc.) storage, aggregation, indexing, recall, etc. and/or (b) as applicable to support any other functionality of ETSN 100, ETSN computer system 102, and/or multiple electricity transfer systems 101. Thus, ETSN computer database 107 can be implemented as any computer database(s) (e.g., XML (Extensible Markup Language) database(s), MySQL database(s), and/or Oracle® database(s)) suitable therefore.

ETSN computer system 102 can be configured to administrate any accounting functions of ETSN 100. Thus, ETSN computer system 102 can be configured to communicate with any applicable financial institution(s) of the ETSN operator, the host(s), and/or the user(s) of ETSN 100 using communication module 106, as described below. Along with administrating the payment schemes of the user(s) of ETSN 100, as described below, ETSN computer system 102 can also be configured to administrate any revenue splitting between the ETSN operator and any other parties (e.g., the host(s), etc.). ETSN computer system 102 can be configured to aggregate and/or store any suitable financial information at ETSN computer database 107, such as, for example, financial information for auditing by a governmental tax authority. ETSN computer system 102 can also administrate any refunds and administrate whether or not member user(s) of ETSN 100 are presently in good standing with ETSN 100.

Some or all of any data stored at ETSN computer database 107 and/or communicated between ETSN 102, multiple electricity transfer systems 101, the third-party resource computer system(s), and/or the personal computer systems of the user(s) of ETSN 100 via communication module 106 can be maintained according to any suitable security standards, such as, for example, to protect personally identifying information of the user(s) of ETSN 100 and/or to satisfy any personally identifying information statutes to which the ETSN operator is subject. Exemplary security standards can comprise the International Organization for Standardization (ISO)/International Electrotechnical Commission (IEC) 27001 security standard, Payment Card Industry Data Security Standards (PCI DSS), Defense Information Systems Agency Secure Technical Implementation Guides (DISA STIGs), etc. Additionally, ETSN computer system 102 can further be secured by periodic (e.g., daily, weekly, monthly, etc.) vulnerability scanning of third-party vulnerabilities by one or more White Hat security companies. Likewise, ETSN 102 can also be secured by server-side digital certificates, client-side digital certificates, and/or Transport Layer Security (TLS)/Secure Sockets Layer (SSL) cryptographic protocols. In some embodiments, some or all of any data stored at ETSN computer database 107 and/or communicated between ETSN 102, multiple electricity transfer systems 101, the third-party resource computer system(s), and/or personal computer system(s) of the user(s) of ETSN 100 via communication module 106 can be unsecured.

Meanwhile, with respect to multiple electricity transfer systems 101, each electricity transfer system (e.g., electricity transfer system 108) of multiple electricity transfer systems 101 can comprise electric vehicle supply equipment. Accordingly, as electric vehicle supply equipment, multiple electricity transfer systems 101 can each be coupled to one or more electric grids and can each permit the user(s) of ETSN 100 to transfer electricity between that particular electricity transfer system (e.g., electricity transfer system 108) and one or more rechargeable energy storage systems (e.g., rechargeable energy storage system 104) corresponding to one or more electric vehicles (e.g., electric vehicle 103) of the respective user(s) of ETSN 100. That is, each electricity transfer system (e.g., electricity transfer system 108) of multiple electricity transfer system 101 can transfer electricity (a) from that electricity transfer system to the rechargeable energy storage system (e.g., to charge the rechargeable energy storage system) and/or (b) to that electricity transfer system from the rechargeable energy storage system, such as, for example, so that the electricity transfer system can make that electricity available to the electric grid(s) (e.g., vehicle-to-grid energy transfer) for energy demand reduction and/or any of various ancillary services (e.g., (1) reactive electric power/electric voltage control, (2) electric loss compensation, (3) electric load following, (4) electric grid protection, and/or (5) electric energy balancing, etc.).

The electric vehicle supply equipment can comprise any suitable alternating current and/or direct current electric vehicle supply equipment. For example, multiple electricity transfer systems 101 can comprise electric vehicle supply equipment configured according to any one of the Society of Automotive Engineers (SAE) International electric vehicle supply equipment standards (e.g., Level 1, Level 2, and/or Level 3) and/or the International Electrotechnical Commission (IEC) standards (e.g., Mode 1, Mode 2, Mode 3, and/or Mode 4). Furthermore, the electric vehicle supply equipment can comprise extended charge electric vehicle supply equipment and/or fast charge electric vehicle supply equipment. The terms “extended charge electric vehicle supply equipment” and “fast charge electric vehicle supply equipment” are relative to each other and the expressed meanings for each can be dictated by the ETSN operator, but can generally be distinguished by the speed with which each is capable of transferring electricity (i.e., where “fast charge electric vehicle supply equipment” transfers a same quantity of electricity in a shorter amount of time than “extended charge electric vehicle supply equipment”). For example, the extended charge electric vehicle supply equipment can comprise alternating current SAE Level 2 electric vehicle supply equipment while the fast charge electric vehicle supply equipment can comprise SAE direct current Level 2 electric vehicle supply equipment. In further examples, when an electricity transfer system (e.g., electricity transfer system 108) of multiple electricity transfer system 101 comprises the fast charge electric vehicle supply equipment, that electricity transfer system can be configured to transfer electricity from that electricity transfer system to a rechargeable energy storage system (e.g., to charge the rechargeable energy storage system) up to approximately eighty percent of the energy capacity of that rechargeable energy storage system in approximately thirty minutes or less. In these or other embodiments, extended charge electric vehicle supply equipment and fast charge electric vehicle supply equipment can also be distinguished by the user fee structure applying to each, as described in further detail below.

Meanwhile, each of the rechargeable energy storage systems (e.g., rechargeable energy storage system 104) can be configured to provide electricity to its associated electric vehicle (e.g., electric vehicle 103) of the electric vehicles to provide motive (e.g., traction) electrical power to that electric vehicle and/or to provide electricity to any electrically operated components of that electric vehicle. In some embodiments, each rechargeable energy storage system, (e.g., rechargeable energy storage system 104) can be configured with and/or can comprise an electricity transfer rating of greater than or equal to approximately (⅛)C (e.g., approximately (¼)C, approximately (⅓)C, approximately (½)C, approximately 1C, approximately 2C, approximately 3C, etc.), where the electricity transfer rating refers to an electricity charge and/or discharge rating of that rechargeable energy storage system (e.g., rechargeable energy storage system 104) in terms of the electric current capacity of the rechargeable energy storage system in ampere-hours. Furthermore, each rechargeable energy storage system (e.g., rechargeable energy storage system 104) can also be configured with and/or can comprise an electric energy storage capacity of greater than or equal to approximately 1 kiloWatt-hour (kW-hr). For example, each rechargeable energy storage system (e.g., rechargeable energy storage system 104) can be configured with and/or can comprise an electric energy storage capacity of greater than or equal to approximately 20 kW-hrs and less than or equal to approximately 50 kW-hrs. In further examples, each rechargeable energy storage system (e.g., rechargeable energy storage system 104) can be configured with and/or can comprise an electric energy storage capacity of greater than or equal to approximately 5 kW-hrs and less than or equal to approximately 100 kW-hrs.

In specific examples, each rechargeable energy storage system (e.g., rechargeable energy storage system 104) can comprise (a) one or more batteries and/or one or more fuel cells, (b) one or more capacitive energy storage systems (e.g., super capacitors such as electric double-layer capacitors), and/or (c) one or more inertial energy storage systems (e.g., one or more flywheels). In many embodiments, the one or more batteries can comprise one or more rechargeable and/or non-rechargeable batteries. For example, the one or more batteries can comprise one or more lead-acid batteries, valve regulated lead acid (VRLA) batteries such as gel batteries and/or absorbed glass mat (AGM) batteries, nickel-cadmium (NiCd) batteries, nickel-zinc (NiZn) batteries, nickel metal hydride (NiMH) batteries, zebra (e.g., molten chloroaluminate (NaAlCl₄)) batteries, and/or lithium (e.g., lithium-ion (Li-ion)) batteries.

Furthermore, each electric vehicle (e.g., electric vehicle 103) can comprise any full electric vehicle, any hybrid vehicle, and/or any other grid-connected vehicle. In the same or different embodiments, each electric vehicle (e.g., electric vehicle 103) can comprise any one of a car, a truck, motorcycle, a bicycle, a scooter, a boat, a train, an aircraft, an airport ground support equipment, and/or a material handling equipment (e.g., a fork-lift), etc.

Each electricity transfer system (e.g., electricity transfer system 108) of multiple electricity transfer systems 101 can be configured to communicate with ETSN computer system 102 via communication module 106. Communication module 106 can comprise a communication network comprising (a) one or more components configured to provide wired communication (e.g., one or more data buses, such as, for example, universal serial bus(es); one or more networking cables, such as, for example, coaxial cable(s), optical fiber cable(s), twisted pair cable(s); any other suitable data cable, etc.) and/or (b) one or more components configured to provide wireless communication (e.g., one or more radio transceivers, one or more infrared transceivers, etc.) between ETSN computer system 102, multiple electricity transfer systems 101 (e.g., electricity transfer system 108), any host computer system(s), any personal computer system(s), and/or any third-party resource computer system(s) leveraged by ETSN 100. Communication module 106 can be configured to operate using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The components forming the communication network of communication module 106 can be dependent on the network topologies and/or protocols in use, and vice versa. For purposes of convenience, communication module 106 is illustrated as being part of ETSN computer system 102. However, in implementation, communication module 106 can also be part of multiple electricity transfer systems 101 (e.g., electricity transfer system 108) and/or any other components with which communication module 106 is configured to permit communication (e.g., any applicable third-party resource computer system(s), any applicable host computer system(s), any applicable personal computer system(s), etc.). In general, in many embodiments, though not to be taken as limiting, some or all of the communications between the host(s) and/or the user(s) with ETSN computer system 102 and/or the ETSN operator can occur via their respective host computer system(s) and/or personal computer system(s), respectively. Exemplary host computer system(s) can comprise desktop computer system(s), laptop computer system(s), and/or any suitable mobile electronic computer system(s), such as, for example, a tablet computer system(s), and/or a smart phone(s), etc. of the host(s). Meanwhile, the personal computer system(s) can be similar to the host computer system(s) but with respect to the user(s) of multiple electricity transfer system(s) 101. Accordingly, in many embodiments, similar to ETSN computer system 101, each of the host computer system(s) and/or the personal computer system(s) can be similar or identical to computer system 1200 (FIG. 12).

In some embodiments, the ETSN operator and/or ETSN computer system 102 can use communication module 106 to provide notifications to the user(s) of ETSN 100, such as, for example, via communication with one or more personal computer systems (e.g., desktop computer system(s), laptop computer system(s), and/or any suitable mobile computer system(s), such as, for example, tablet computer system(s), and/or smart phone(s), etc.) of the user(s). Exemplary notifications can comprise notice that an electricity transfer has completed, notice that an electricity transfer has been prematurely interrupted, notice of an impending reservation of an electricity transfer system of multiple electricity transfer systems 101, and/or any other suitable notice desired.

Meanwhile, the ETSN operator and/or ETSN computer system 102 can also provide messaging (e.g., physically and/or electronically) to the user(s) and/or any potential user(s) of ETSN 100, such as, for example, via communication with one or more personal computer systems of the user(s), via the user interface(s) (e.g., user interface 110) of multiple electricity transfer systems 101, via pamphlets, via periodicals, via personalize notes, via social media (e.g., social networking) service(s), via media (e.g., audio and/or video media) sharing service(s), via trade magazines, via conferences, via webinars, etc. Exemplary messaging can comprise news, public service announcements, general advertisements, and/or advertisements encouraging use of ETSN 100, such as, for example, by encouraging potential user(s) to become involved with the electric vehicle movement, by encouraging early adoption of ETSN 100, by persuading user(s) that fees for ETSN 100 are necessary for future development of ETSN 100, etc. Additional exemplary messaging can comprise (a) descriptions of the user capacities, price schemes, user fee structures, etc., as described below, (b) advisories of future changes to ETSN 100, (c) instructions on how to become member user(s) and examples of advantages of doing so, (d) suggested and/or mandatory etiquette protocols for using ETSN 100, (d) specific information and/or announcements relating to one or more electricity transfer systems of multiple electricity transfer systems 101 (e.g., electricity transfer system 108), etc.

In further embodiments, the ETSN operator and/or ETSN computer system 102 can use communication module 106 to receive feedback from user(s) and/or host(s) of ETSN 100. This feedback can be used to adapt ETSN 100 over time to better suit the needs of the user(s) and/or the host(s) while also providing a mechanism by which the ETSN operator can better understand the industry of electric vehicle charging.

Each electricity transfer system (e.g., electricity transfer system 108) of multiple electricity transfer systems 101 can comprise a user interface (e.g., user interface 110). The user interface (e.g., user interface 110) can be configured to permit the user(s) of ETSN 100 to operate that electricity transfer system of multiple electricity transfer systems 101 to which the user interface corresponds and can further be configured to communicate with the user(s). Accordingly, the user interface can comprise any suitable input mechanism(s) and/or output mechanism(s) for implementing such control and/or communication. For example, the user interface can comprise one or more touch screen electronic displays. At least one of the touch screen electronic displays can comprise a graphical user interface, and the graphical user interface can be implemented to provide one or more of the input mechanism(s) and/or output mechanism(s). In these or other embodiments, the user interface can also comprise any suitable complimentary input mechanism(s) (e.g., a keyboard, keypad, etc.) and/or output mechanism(s) (e.g., one or more speakers, etc.). Further, the user(s) of ETSN 100 and/or multiple electricity transfer systems 101 can use the user interface (e.g., user interface 110) for authentication purposes (as described in further detail with respect to authentication mechanism 105 and/or authentication module 109), to enter a one-time activation code (as described in further detail below with respect to the pay-per-transaction payment scheme), to become affiliated with (e.g., establish a membership with) ETSN 100 in one or more of the member user capacities, to interface with one or more hosts of multiple electricity transfer systems 101, to engage in other forms of dialogue, such as, for example, with the ETSN operator, etc.

Each electricity transfer system (e.g., electricity transfer system 108) of multiple electricity transfer systems 101 can be configured so that the ETSN operator is able to present third-party data to the user(s) of ETSN 100. The third-party data can be presented (a) electronically via the user interface of that electricity transfer system and/or the personal computer system of the user(s) of ETSN 100 and/or (b) physically via integrating the third-party data with a body, frame, and/or chassis of the electricity transfer system. Where the third-party data is presented electronically, the third-party data can be retrieved (e.g., in real-time) (a) from any applicable third-party resource computer system(s), as described above, via communication module 106 and/or (b) from ETSN computer database 107 (where the third-party data has been previously retrieved from the applicable third-party resource computer system(s) and stored at computer database 107 for future use) via communication module 106.

Exemplary third-party data can comprise energy demand data and/or energy rate data of one or more electric utility companies, marketing data (e.g., (a) advertisement data, such as, for example, host advertisement data and/or (b) any other suitable commercial data, such as, for example, business hours of operation and/or location(s), event times/dates, merchandise costs, merchandise availability, merchandise options, etc.), public service announcements, news, weather, etc. Where a particular electricity transfer system of multiple electricity transfer systems 101 is Internet-access enabled, the third-party data can comprise any data accessible via the Internet. Host advertisement data can be advertisement information relating to any host of multiple electricity transfer systems 101.

Meanwhile, each electricity transfer system (e.g., electricity transfer system 108) of multiple electricity transfer systems 101 can be reserved for future use by the user(s) of ETSN 100, provided the ETSN operator and/or the host of that electricity transfer system permits reservations to be made for that electricity transfer system. Nonetheless, the ability to make reservations can be restricted to the user(s) of ETSN 100 using ETSN 100 and/or multiple electricity transfer systems in certain user capacities (e.g., member user capacities, and/or more specifically, the premium member user capacity), as described below. However, in some embodiments, any user(s) of ETSN 100 can make such reservations. In other embodiments, the user(s) of ETSN 100 are not able to reserve any electricity transfer system (e.g., electricity transfer system 108) of multiple electricity transfer systems 101, or certain electricity transfer system(s) of multiple electricity transfer systems 101 (e.g., where the certain electricity transfer system(s) of multiple electricity transfer systems 101 comprise fast charge electric vehicle supply equipment).

When making reservations, the user(s) of ETSN 100 can be able to reserve use of an electricity transfer system (e.g., electricity transfer system 108) of multiple electricity transfer systems 101 according to predefined increments of time (e.g., second increments, minute increments, tenth-hour increments, sixth-hour increments, quarter-hour increments, half-hour increments, hour increments, etc.) and/or within a desired window of time (e.g., four sequential and/or discontinuous one-hour increments occurring within a twenty-four hour window of time). Further, the user(s) of ETSN 100 can be able to reserve use of an electricity transfer system (e.g., electricity transfer system 108) of multiple electricity transfer systems 101 up to a predetermined amount of time (e.g., seven days) in advance of the reservation time. In these or other embodiments, the user(s) of ETSN 100 can be limited in making a reservation such that the user(s) cannot make the reservation less than another predetermined amount of time (e.g., eight hours) in advance of the reservation time.

Further, when making reservations, the user(s) of ETSN 100 can request to reserve an electricity transfer system (e.g., electricity transfer system 108) of multiple electricity transfer systems 101 meeting certain specifications (e.g., located within a specified region, located within a proximity of a reference location, etc.). ETSN computer system 101 can determine the electricity transfer system of multiple electricity transfer system 101 that most accurately meets these provided specifications. Meanwhile, ETSN computer system 101 can also factor other specifications into selecting an electricity transfer system of multiple electricity transfer systems 101 at which to provide reservation(s) to the user(s). For example, ETSN computer system 101 can assign the reservation at the electricity transfer system of multiple electricity transfer systems 101 that balances electrical demand on the electric grid(s) providing electricity to multiple electricity transfer systems 101. ETSN computer system 101 can also assign the reservation at the electricity transfer system of multiple electricity transfer systems 101 having the highest user rating. In general, ETSN computer system 101 can balance these various specifications, providing equal, less, and/or greater weight to one or more of the specifications.

In the same or different embodiments, the user of ETSN 100 can request a reservation of an electricity transfer system (e.g., electricity transfer system 108) within a general area of multiple electricity transfer systems 101, but ETSN 100 selects the specific electricity transfer system that is reserved for the user. This way, ETSN can more effectively balance the factors mentioned in the previous paragraphs. The ETSN operator can provide an incentive to the user (e.g., lower cost, credits for future use, discounts at affiliated businesses, etc.) for allowing the ETSN operator to select the specific electricity transfer system within a geographic area (e.g., within a 0.25 kilometer (km) radius, a 0.5 km radius, a 0.75 km radius, a 1.0 km radius, etc.).

Assuming a user of ETSN 100 makes a reservation to use an electricity transfer system (e.g., electricity transfer system 108) of multiple electricity transfer systems 101, the reservation can be cancelled by the ETSN operator in the event that the reserving user does not arrive at, interface with, and/or begin using the reserved electricity transfer system within a predetermined time period (e.g., fifteen minutes) after the reservation time. Furthermore, that user can cancel the reservation of the electricity transfer system of multiple electricity transfer systems 101 up to another predetermined time period (e.g., fifteen minutes) in advance of the reservation time without penalty. Meanwhile, the ETSN operator can assess a penalty (e.g., a monetary fine, revocation of reservation rights, etc.) for (a) failure to use the reservation, (b) late cancellation of the reservation, and/or (c) for blocking and/or preventing access to any reserved electricity transfer system of multiple electricity transfer systems 101 during (and/or approximately during) the corresponding reservation time of that electricity transfer system. In the latter most scenario, the penalty can comprise a monetary fine and can be repeatedly assessed for each successive time interval of a predetermined time interval (e.g., every fifteen minutes) (and/or can be increased in monetary amount for each successive time interval) during which a user of ETSN 100 is blocking and/or preventing access to the reserved electricity transfer system of multiple electricity transfer systems 101. In some examples, the monetary fines can be assessed progressively and/or regressively with each successive time interval. In many embodiments, the ETSN operator can provide a disclaimer to a user of ETSN 100 before and/or while the user makes a reservation where the disclaimer notifies the user of one or more causes for which the reservation penalties described herein are assessed.

In some embodiments, the ETSN operator can also assess a reservation fee to any user(s) of ETSN 100 requesting to make and/or receiving a reservation. Such reservation fee can alternatively be omitted or reduced for any user(s) using ETSN 100 and/or multiple electricity transfer systems 101 in certain operating capacities. Where the ETSN operator assesses a reservation fee for making and/or receiving the reservation, the ETSN operator can request a block and/or a hold on a revolving account (e.g., charge card, credit card, debit card, etc.) of the reserving user at the time the reservation is requested, made, and/or at a predetermined time (e.g., eight hours) before the time of the reservation.

The ETSN operator can notify the user(s) which electricity transfer system(s) (e.g., electricity transfer system 108) of multiple electricity transfer systems 101 are presently reserved for use or reserved for future use via the user interface(s) of those electricity transfer system(s) and/or one or more personal computer systems of the user(s). For example, the ETSN operator can provide such notification via an electricity transfer system network (ETSN) map, described in greater detail below. The same ETSN map can also aid in permitting any user(s) of ETSN 100 to make reservations of any electricity transfer system(s) of multiple electricity transfer systems 101. The ETSN operator also can: (a) limit the amount of time that any one user of ETSN 100 can reserve to use an electricity transfer system of multiple electricity transfer systems 101; (b) limit the number of electricity transfer systems of multiple electricity transfer systems 101 that any one user of ETSN can have reserved during a predefined period of time; and/or (c) provide a buffer window between reservations at the same electricity transfer system of multiple electricity transfer systems 101 to reduce the likelihood of reservation overlap and/or user conflict.

When the reservation(s) are made, the user(s) of ETSN 100 can be provided an identifier (e.g., an identification number, a word, etc.) to provide to a reserved electricity transfer system of multiple electricity transfer systems 101 to redeem the reservation(s). This identifier can also be used by the ETSN operator to identify the particular reservation with which the identifier is associated. Further, the reservation(s) can be stored locally at the relevant electricity transfer system(s) of multiple electricity transfer systems 101 in local reservation list(s) of the relevant electricity transfer system(s) of multiple electricity transfer systems 101. Accordingly, each electricity transfer system of multiple electricity transfer systems 101 can be configured to synchronize (e.g., periodically) with ETSN computer system 102 to permit ETSN 102 to keep the Internet portal up to date for user(s) of ETSN 100 to make remote reservations of multiple electricity transfer systems 101. User(s) of ETSN 100 and/or multiple electricity transfer systems 101 attempting to make a reservation can be listed sequentially within a reservation queue (e.g., based on a first-come first-serve basis, providing priority to member user(s), etc.) and permitted to make their respective reservations according to their position in the reservation queue. If the user(s) of ETSN 100 fail to complete their reservation within a predetermined quantity of queue time, the user(s) can lose their position in the queue.

Furthermore, each electricity transfer system (e.g., electricity transfer system 108) of multiple electricity transfer systems 101 can be configured to authenticate an identity of the user(s) of ETSN 100 when the user(s) use ETSN 100 and/or multiple electricity transfer systems 101 in certain user capacities (e.g., the member user capacities, the fleet user capacity, etc.), as described below. In this manner, the relevant electricity transfer system (e.g., electricity transfer system 108) of multiple electricity transfer systems 101 can confirm a user of ETSN 100 is a bonafide member user, fleet user, etc. of ETSN 100 and that the member user, fleet user, etc. is in good standing with the ETSN operator. Thus, each electricity transfer system (e.g., electricity transfer system 108) of multiple electricity transfer systems 101 can comprise an authentication module (e.g., authentication module 109) configured to communicate with authentication mechanism(s) (e.g., authentication mechanism 105) of the relevant user(s) of ETSN 100 that corresponds and/or is assigned to the authentication mechanism(s), respectively. In many embodiments, where applicable, the authentication mechanism (e.g., authentication mechanism 105) can be provided by and/or issued by the ETSN operator to the member user(s), fleet user(s), etc. of ETSN 100.

When member user(s) of ETSN 100 make reservation(s) through their member user profile(s), the member user(s) can also be provided with a calendar providing past, current, and/or future reservations of multiple electricity transfer systems 101. Further, using the ETSN map, as described herein, member user(s) can also locate reference locations, events, etc. proximate to each electricity transfer system of multiple electricity transfer systems 101, such as, for example, to help the member user(s) of ETSN 100 to determine at which electricity transfer system(s) of multiple electricity transfer systems 101 to make reservations. Likewise, member user(s) can view past travel patterns to assist the member user(s) in making future reservations. In some embodiments, the member user(s) can disable and/or erase tracking of some or all past reservations of multiple electricity transfer systems 101.

Accordingly, the authentication mechanism(s) (e.g., authentication mechanism 105) can comprise any suitable mechanism(s) permitting identification and the authentication module(s) can comprise any suitable device(s) configured to communicate with and/or receive the authentication mechanism(s). Exemplary authentication mechanisms can comprise a radio frequency identification card and/or fob, a password/pass code (e.g., provided to authentication module 109 via user interface 110 and/or the one or more personal computer system(s)), a magnetic stripe card, such as, for example, a magnetic stripe card associated with a revolving account of the relevant user of ETSN 100, a fingerprint, retina, face, etc. of the relevant user of ETSN 100 (where the authentication module comprises a fingerprint scanner, a retina scanner, a facial recognition scanner, etc.

Each authentication module (e.g., authentication module 109) of each electricity transfer system (e.g., electricity transfer system 108) of multiple electricity transfer systems 101 can be configured to reference any authentication mechanism against a master user list of deactivated authentication mechanisms that is stored at ETSN computer database 107 of ETSN computer system 102 using communication module 106. In this manner, the authentication module(s) (e.g., authentication module 109) can determine whether or not member user(s), fleet user(s), etc. are in good standing with ETSN 100 and to revalidate any authentication mechanism(s) in the event the corresponding user(s) regain such good standing, such as, for example, by settling outstanding payments with the ETSN operator. However, in the event, that any authentication module is unable to communicate with ETSN computer system 102 at a time when authentication of the user(s) of ETSN 100 is needed, each electricity transfer system (e.g., electricity transfer system 108) can also be configured to maintain and/or store locally its own local user list of deactivated authentication mechanism to be referenced in the absence of the master user list. Accordingly, to maintain accuracy, each electricity transfer system (e.g., electricity transfer system 108) of multiple electricity transfer systems 101 can be configured to periodically synchronize its local user list with the master user list of ETSN computer database 107.

Each electricity transfer system (e.g., electricity transfer system 108) of multiple electricity transfer systems 101 can comprise a local timing module (e.g., comprising a clock and/or counting system) and/or an electricity metering module (e.g., comprising any suitable electricity meter, such as, for example, a smart electricity meter). Each local timing module can be configured to periodically synchronize itself against a master timing module (e.g., comprising a master clock and/or counting system) of ETSN computer system 102. The local timing module(s) of multiple electricity transfer systems 101 can be configured as a slave(s) to the master timing module such that the local timing module(s) do not attempt to reset themselves without approval from the master timing module. The local timing module(s) can perform any timing functionality of the electricity transfer system(s) of multiple electricity transfer systems 101, and the electricity metering module(s) can measure any electricity transferred by the electricity transfer system(s). Meanwhile, the master timing module can perform any timing functionality for ETSN computer system 102.

Each electricity transfer system (e.g., electricity transfer system 108) can comprise an electricity transfer system (ETS) computer system (e.g., ETS computer system 111). The ETS computer system(s) can be configured to implement at least some of the functionality of that electricity transfer system(s). Further, each electricity transfer system (e.g., electricity transfer system 108) can be designed to withstand at least some level of physical tampering to prevent security breaches, such as, for example, of the electricity transfer system(s), thus mitigating and/or preventing subversion of ETSN 100.

Each electricity transfer system (e.g., electricity transfer system 108) of multiple electricity transfer systems 101 can be owned by a host, leased by the host, and/or made available by the host for use by one or more of the user(s) of ETSN 100. In many embodiments, one host can own, lease, and/or make available more than one electricity transfer system of multiple electricity transfer systems 101, where the host's electricity transfer systems can be located substantially together and/or remotely from each other. Although in some embodiments, the host(s) of multiple electricity transfer systems 101 can comprise the ETSN operator, in many embodiments, the host(s) can additionally or alternatively comprise one or more commercial hosts (e.g., government(s), business(es), utility company/companies, school(s), communal living establishment(s), such as, for example, a condo and/or apartment complex, etc.) and/or one or more private hosts (e.g., hosts using their electricity transfer system without compensation for use) making their electricity transfer system(s) available in a commercial capacity (e.g., in exchange for compensation). Each host (e.g., the commercial host(s)) can be affiliated with, can cooperate with, and/or can participate in ETSN 100 such that their electricity transfer system(s) are included as part of multiple electricity transfer systems 100 and therefore, are made available for use by the user(s) of ETSN 100. To maintain and/or expand the scope of ETSN 100, the ETSN operator can take measures to incentivize the host(s) to affiliate with, cooperate with, and/or participate in ETSN 100, as is described in detail below. In some embodiments, where the host(s) comprise commercial host(s), the commercial host(s) can make their electricity transfer system(s) of multiple electricity transfer systems 101 available to the user(s) of ETSN 100 and/or multiple electricity transfer systems 101 at desirable parking spot(s) at the respective properties. For example, the commercial host(s) can make their electricity transfer system(s) of multiple electricity transfer systems 101 available to the user(s) of ETSN 100 and/or multiple electricity transfer systems 101 at those parking spot(s) located nearest to one or more buildings on the respective properties.

By affiliating with ETSN 100, the host(s) can also improve their recognition as being environmentally friendly (e.g., green), as being a desirable employer for whom to work by providing electric vehicle charging opportunities to employees (e.g., via the fleet user capacities), and/or as being involved with the local community by providing commercial and/or free electric vehicle charging opportunities to the public. Thus, these factors can also incentivize the host(s) to affiliate with ETSN 100. Moreover, where the commercial hosts are government(s), the governments can simply be performing governmental purposes of providing infrastructure to the public by affiliating with ETSN 100. In some embodiments, the ETSN operator can provide (e.g., for a charge and/or free of charge) one or more electricity transfer system(s) of multiple electricity transfer systems 101 to the commercial host(s) in exchange for affiliating with ETSN 100.

Each electricity transfer system of multiple electricity transfer systems 101 can be configured to collect any suitable and/or desirable usage data relating to the user(s) of ETSN 100 when the user(s) use that electricity transfer system of multiple electricity transfer systems 101.

Moving forward while considering the details relating to multiple electricity transfer systems 101, as described above, ETSN 100 can be organized such that the user(s) of ETSN 100 can use ETSN 100 and/or multiple electricity transfer systems 101 in various user capacities (e.g., two or more user capacities, three or more user capacities, etc.). Many embodiments can implement as many user capacities as are desirable. For example, the user capacities can comprise a guest user capacity, one or more member user capacities (e.g., a basic member user capacity, a premium member user capacity, etc.), one or more fleet user capacities, and/or a free user capacity. In various embodiments, the user capacities can comprise two or more member user capacities. In some embodiments, the user(s) of ETSN 100 can use ETSN 100 and/or multiple electricity transfer systems 101 in one of these user capacities and/or simultaneously in multiple of the user capacities. In many embodiments, the user capacities can be established by the ETSN operator (and/or by one or more of the host(s), where desirable). Operating the ETSN 100 with multiple user capacities (e.g., two or more user capacities) provides the user(s) with choices so that the user(s) can use ETSN 100 in the user capacity to which the user(s) is best and/or preferentially suited. As a result, people can be more likely to use ETSN 100, which promotes and/or encourages electric vehicle use and/or charging. The details pertaining to each of these exemplary user capacities are described below, and in additional detail with respect to the payment schemes and user fee structures, introduced below.

When the user(s) of ETSN 100 use ETSN 100 and/or multiple electricity transfer systems 101 in one of the member user capacities, the user(s) of ETSN 100 is an affiliate (e.g., a member) of ETSN 100 and, thus, can make use of certain support that can be and/or certain services that can be provided by ETSN 100 that is and/or are not necessarily available to the user(s) of ETSN 100 when using ETSN 100 and/or multiple electricity transfer systems 101 in one of the other (e.g., non-member user capacities, such as, for example, the guest user capacity). Meanwhile, the member user capacities can also be tiered such that any user(s) of ETSN 100 using ETSN 100 and/or multiple electricity transfer systems 101 in certain member user capacities (e.g., the premium member user capacity) receive more support than is and/or more services than are provided for other member user capacities (e.g., the basic member user capacity). Any user(s) using ETSN 100 and/or multiple electricity transfer systems 101 in one of the member user capacities can be referred to as a member user(s). In some embodiments, a first-tier member user capacity can refer to the basic member user capacity, and a second-tier member user capacity can refer to the premium member user capacity. Further, many embodiments can implement as many tiers of member user capacities as are desirable. Meanwhile, although the support and/or services afforded to the member user(s) is/are described below as being limited to the member user(s), as indicated above, there can be other embodiments of ETSN 100 where some of this support and/or these services can be afforded to the user(s) of the other user capacities.

In various examples of support and/or services provided by ETSN 100 to the member user(s), the member user(s) can establish member user account(s) corresponding to the respective member user(s). The member user account(s) can be maintained by the ETSN operator. The member user(s) can also establish (and customize) a member user profile(s) corresponding to their member user account(s). The member user profile(s) can be made accessible to the member user(s) via an Internet portal of ETSN 100. The member user profile(s) can permit member user(s) (a) to manage the member user account(s) (e.g., providing personal information, providing charging preferences and/or requirements, settling outstanding payments with ETSN 100, etc.), (b) to access and/or review usage data corresponding to the member user(s), (c) to view notifications from the ETSN operator, etc. Using the Internet portal, the member user(s) can also (a) make reservation(s) to use one or more electricity transfer systems of multiple electricity transfer systems 101, as described above, (b) view messaging of the ETSN operator, (c) view third-party data provided by the ETSN operator, (d) learn about and/or obtain access to one or more events (described below with respect to the member user incentives), etc. The usage data can comprise electric vehicle data, rechargeable energy storage system data, user habit data, etc. Exemplary electric vehicle data can comprise maintenance requirements for the member user's electric vehicle(s), locations of the member user's electric vehicle(s) (e.g., provided by a global positioning system of the electric vehicle(s)), make(s)/year(s)/model(s) of the member user's electric vehicle(s), previous driving statistics of the member user's electric vehicle(s) (e.g., distances traveled, routes taken, speeds driven, etc., since the last charge or since a predetermined date or time), odometer reading(s) of the member user's electric vehicle(s), etc. Meanwhile, exemplary rechargeable energy storage system data can comprise a measured and/or calculated internal temperature of the rechargeable energy storage system of the member user's electric vehicle(s), a measured and/or calculated internal pressure of the rechargeable energy storage system of the member user's electric vehicle(s), a measured and/or calculated internal resistance free electric voltage of the rechargeable energy storage system of the member user's electric vehicle(s), a state of charge of the rechargeable energy storage system of the member user's electric vehicle(s), a state of health of the rechargeable energy storage system of the member user's electric vehicle(s), a measured and/or calculated electric current at the rechargeable energy storage system of the member user's electric vehicle(s), a measured and/or calculated electric voltage at the rechargeable energy storage system of the member user's electric vehicle(s), etc. Exemplary member user habit data can comprise use, location, and/or time of use statistics pertaining to favorite and/or most commonly used electricity transfer system(s) of multiple electricity transfer systems 101 used by the member user, spending habits, etc. of the member user's. In many embodiments, the member user(s) can access the Internet portal and/or their member profiles via the user interface(s) of multiple electricity transfer systems 101 and/or via their personal computing systems.

Similarly, the ETSN operator can maintain operator profiles (1) corresponding to the member accounts and/or to any user(s) of ETSN 100 (a) that aggregate usage data pertaining to the user(s) and (b) that make available that usage data to the ETSN operator for study/research, for improvement of ETSN 100, and/or (2) to provide at least some of the usage data to host(s) in host report(s), as described in greater detail below. As a general matter, although the usage data is described here with respect to the member user(s), usage data of any of the user(s) of ETSN 100 can be collected, aggregated, and/or stored at ETSN computer database 107 along with the member profiles and/or operator profiles.

In further examples of support and/or services provided by ETSN 100 to the member user(s), as described above, the ETSN operator can make available an ETSN map in the form of a graphical user interface provided at the Internet portal. The ETSN map can permit user(s) and/or member user(s), as applicable, to make reservations for, check the availability of, and/or locate any of multiple electricity transfer systems 101. The user(s) and/or member user(s) can also determine the type(s) of electric vehicle supply equipment (e.g., fast charge, extended charge, etc.) for any of multiple electricity transfer systems 101, the cost(s) (e.g., pursuant to the user fee structure(s)) associated with using any of multiple electricity transfer systems 101, and/or whether one or more reference locations (e.g., businesses such as restaurants, entertainment venues, retail stores, gymnasiums, etc.; government buildings such as libraries, schools, post offices, court houses, etc.; parks; etc.) are located near any of multiple electricity transfer systems 101.

In still further examples of support and/or services provided by ETSN 100 to the member user(s), as described above, the ETSN operator can make available application software for mobile electronic device(s) (e.g., smart phones, etc.). The application software can provide mobile access to some and/or all of the support and/or services provided by ETSN 100. For example, the application software can be used by member user(s) to access their member user profile(s) (e.g., to provide suitable functionality of the member user profile(s), as described above), to access and use the ETSN map, to make reservations to use multiple electricity transfer systems 101 (e.g., via the ETSN map), etc. In some embodiments, other user(s) of ETSN 100 and/or multiple electricity transfer systems 101 can also use the application software.

Accordingly, in order to become affiliated with ETSN 100, the ETSN operator can require the user(s) of ETSN 100 to enter into a membership contract (e.g., requiring different obligations of the user(s) depending on the desired membership user capacity) with ETSN operator. Meanwhile, in these or other embodiments, the ETSN operator can charge and/or bill the user(s) of ETSN 100 a membership fee (e.g., thirty United States dollars) in order for the user(s) to be able to use ETSN 100 and/or multiple electricity transfer systems 101 in at least one of the two or more member user capacities (e.g., the basic member user capacity and/or the premium member user capacity). For example, the membership fee can comprise an upfront (e.g., initial and/or joining) membership fee and/or a recurring (e.g., monthly, annual, etc.) membership fee. In some examples, membership fees can be non-refundable. In further examples, where membership fees are tiered over the membership user capacities, a membership fee paid for a lower membership user capacity can be applied toward upgrading to a higher membership user capacity.

As indicated above, authentication of member user status can be confirmed via an authentication mechanism (e.g., authentication mechanism 105) corresponding to the relevant user(s) of ETSN 100. Generally speaking, the member user capacity can be associated with the pay-per-period payment scheme, as described below. Likewise, the basic member user capacity can be associated with the basic member fee structure, and the premium member user capacity can be associated with the premium member fee structure, each being described below.

When the user(s) of ETSN 100 use ETSN 100 and/or multiple electricity transfer systems 101 in the guest user capacity, the user(s) of ETSN 100 is not an affiliate (e.g., member user(s)) of ETSN 100 and, thus, can make limited or no use of the various support that can be provided and/or the various services that can be provided by ETSN 100 as described above with respect to the member user capacities. For example, in the guest user capacity, use of ETSN 100 and/or multiple electricity transfer systems 101 by the user(s) (e.g., guest user(s)) of ETSN 100 can be limited to using multiple electricity transfer systems 101 to transfer electricity to the rechargeable energy storage system (e.g., rechargeable energy storage system 104) of their electric vehicle (e.g., electric vehicle 103) only, and without making a reservation to do so. Implementing the guest user capacity of the various user capacities can permit the user(s) of ETSN 100 that do not want to be member user(s) to still make use of ETSN 100, thereby providing at least some revenue to the ETSN operator that could otherwise be lost and providing the ETSN operator with opportunities to persuade the guest user(s) to become member user(s).

Although user(s) of ETSN 100 in the guest user capacity are not necessarily subject to authentication in the same manner as user(s) of ETSN 100 in the member user capacities, the guest user(s) can still be subject to a special form of guest authentication pertaining to the pay-per-transaction scheme, as described below. Accordingly, the guest user capacity can be associated with the pay-per-transaction payment scheme and the guest user fee structure, as described below.

Meanwhile, when the user(s) of ETSN 100 use ETSN 100 and/or multiple electricity transfer systems 101 in the fleet user capacities, the user(s) of ETSN 100 (e.g., fleet user(s)) is an affiliate of ETSN 100 through his corresponding host(s) (i.e., where the host(s) (e.g., fleet host(s)) own, lease, and/or make available the electricity transfer system(s) (e.g., electricity transfer system 108) of multiple electricity transfer systems 101 and opt to permit select user(s) of ETSN 100 (e.g., fleet user(s)) to use their electricity transfer system(s) in the fleet user capacity). For example, the host(s) could comprise an employer and the fleet user(s) can comprise one or more employees of the host(s). Accordingly, the fleet user(s) of ETSN 100 can, in many examples, make use of the support and/or services provided by ETSN 100 in a manner similar or identical to that of one or more of the member user capacities. However, under the fleet user capacity, the fleet host(s) can determine the payment schemes associated with using ETSN 100 and/or multiple electricity transfer systems 101 and/or payment can be handled by the host(s) instead of the fleet user(s) of ETSN 100. The fleet user capacity can also operate as an incentive for the host(s) of multiple electricity transfer systems 101 to affiliate with ETSN 100 as described in further detail below.

In implementation, the fleet user capacities can comprise (a) a restricted-campus fleet user capacity, (b) an open-campus fleet user capacity, and/or (c) a campus/on-road fleet user capacity. The (a) restricted-campus fleet user capacity, (b) open-campus fleet user capacity, and/or (c) campus/on-road fleet user capacity can be distinguished from each other by factors such as access, associated payment scheme, authentication requirements, etc.

Under the restricted-campus fleet user capacity, the electricity transfer system(s) (i.e., of multiple electricity transfer systems 101) of the fleet host(s) can be configured for restricted access by physical barrier(s), such as, for example, gates and/or walls such that only user(s) of ETSN 100 with access to the restricted area can use the electricity transfer system(s) of the host(s). The restricted-campus fleet use capacity can be associated with any of the payment schemes and can optionally require authentication via an authentication mechanism.

The open-campus fleet user capacity can be similar to the restricted-campus fleet user capacity, but where the electricity transfer system(s) (i.e., of multiple electricity transfer systems 101) of the fleet host(s) can be open and accessible (e.g., without restricted access) for the user(s) of ETSN 100 to use in the guest user capacity as well. Thus, fleet user(s) and guest user(s) can be subject to different payment schemes and user fee structures.

Under the campus/on-road fleet user capacity, host-specific authentication mechanisms can be provided and/or issued to the fleet host(s) to provide and/or issue to their fleet user(s) so that those fleet user(s) can use the electricity transfer system(s) (i.e., of multiple electricity transfer systems 101) of the fleet host(s) in either of the restricted-campus fleet user capacity or the open-campus fleet user capacity while also using any other electricity transfer system(s) of multiple electricity transfer systems 101. The host-specific authentication mechanisms can associate fleet user(s) of ETSN 100 with their respective fleet host(s) when those fleet user(s) use any other electricity transfer system(s) of multiple electricity transfer systems 101 than those of the fleet host(s).

Furthermore, the free user capacity can refer to a user capacity where the user(s) of ETSN 100 and/or multiple electricity transfer systems 101 can make open use thereof according to the non-payment payment scheme, as explained below. The ability to use ETSN 100 and/or any electricity transfer system(s) of multiple electricity transfer systems 101 in the free user capacity can be dictated by the ETSN operator and/or the relevant host(s). In the event that the host(s) permit use of any electricity transfer system(s) of multiple electricity transfer systems 101 in the free user capacity, the host(s) can be responsible for making payments to the ETSN operator and/or the local utility company for such use instead of the user(s) of ETSN 100. As indicated above, in some embodiments, the host(s) can comprise the ETSN operator. In these examples, if the relevant host permitting use of any particular electricity transfer system(s) of multiple electricity transfer systems 101 is the ETSN operator, the ETSN operator can cover the costs of the transactions conducted in the free user capacity with those relevant electricity transfer system(s). In still other embodiments, one or more third parties can be responsible for making payments to the ETSN operator to cover the costs of the transactions conducted in the free user capacity.

In various embodiments, the user(s) of ETSN 100 and/or multiple electricity transfer systems 101 can use ETSN 100 and/or multiple electricity transfer systems 101 according to the non-payment payment scheme (and/or one or more discounted payment schemes) by redeeming electricity transfer credits (e.g., virtual currency to be used with ETSN 100) and/or electricity transfer coupons, either or both of which can be provided by the host(s) and/or the ETSN operator. In some examples the electricity transfer coupons can be redeemed to use ETSN 100 and/or multiple electricity transfer systems 101 according to the non-payment payment scheme for a single use while in other embodiments, the electricity transfer coupons can be redeemed for multiple uses. Further, in various embodiments, each electricity transfer coupon of the electricity transfer coupons can comprise a corresponding coupon code which can be provided at one or more electricity transfer systems of multiple electricity transfer systems 101 in order to redeem that electricity transfer coupon. For example, the coupon code can be provided at the user interface (e.g., user interface 110) of the electricity transfer system (e.g., electricity transfer system 108) in order to redeem the electricity transfer coupon. Meanwhile, the same coupon code can also be stored at the electricity transfer system (e.g., electricity transfer system 108) such that the electricity transfer system can authenticate the coupon code and accordingly, the electricity transfer coupon, upon redemption. In other embodiments, the coupon code can be stored remotely at ETSN computer system 102 and referenced as necessary by the electricity transfer system (e.g. electricity transfer system 108) via communication module 106.

The ETSN operator can receive payment from and/or bill the user(s) of ETSN 100 for use of any electricity transfer system(s) of multiple electricity transfer systems 101 according to two or more payment schemes that dictate the manner in which the user(s) provide payment to the ETSN operator. For example, the payment scheme(s) can comprise a pay-per-transaction payment scheme, a pay-per-period payment scheme, and/or a non-payment payment scheme. Still, in other embodiments, the payment scheme(s) can comprise any suitable payment schemes. The ETSN operator can establish the payment schemes associated with the user capacities (except in the case of fleet host(s) where those fleet host(s) desire to establish the payment schemes associates with the fleet host capacities). As indicated above, in some embodiments, the fleet host(s) can settle the payment schemes on behalf of the fleet user(s).

Under the pay-per-transaction payment scheme, the user(s) of ETSN 100 can authorize the ETSN operator to charge and/or bill the user(s) on a one-off basis in exchange for use of an electricity transfer system of multiple electricity transfer systems 101. For example, the user(s) of ETSN 100 can authorize the ETSN operator to charge and/or bill the user(s) via a revolving account (e.g., charge card, credit card, debit card, etc.), cash, an e-commerce account from a provider such as PayPal of San Jose, Calif., etc. on a one-off basis. Upon receiving such authorization, the ETSN operator can provide a one-time activation code (e.g., a guest activation code, as described above) to the relevant user(s) of ETSN 100 that the relevant user(s) can then use in turn to activate the relevant electricity transfer system for use (e.g., a single use). For example, the user(s) can provide the one-time activation code at the user interface (e.g., user interface 110) associated with the electricity transfer system (e.g., electricity transfer system 108) of multiple electricity transfer systems 101. The ETSN operator can provide the one-time activation code to the user(s) of ETSN 100 at their personal computing system (e.g., a smart phone and/or personal computer) via communication module 106. The one-time activation code can be deactivated if the user(s) do not use the one-time activation code within a predetermined time window (e.g., twenty-four hours) of receiving the one-time activation code. In the event the one-time activation code is deactivated, the ETSN operator may or may not issue a refund to the user(s). In many examples, when the user(s) of ETSN 100 uses multiple electricity transfer systems 101 in the guest user capacity, the ETSN operator can receive payment from the user(s) according to the pay-per-transaction payment scheme, as indicated above.

Meanwhile, under the pay-per-period payment scheme, the user(s) of ETSN 100 can authorize the ETSN operator to (regularly) charge and/or (regularly) bill the user(s) upon the passage and/or occurrence of a predetermined time interval (e.g., period of time). For example, the ETSN operator can authorize the user(s) of ETSN 100 to (regularly) charge and/or (regularly) bill the user(s) (e.g., a revolving account, a bank checking account, an e-commerce account from a provider such as PayPal of San Jose, Calif., etc. of the user(s)) of ETSN 100 for any uses of multiple electricity transfer systems 101 during the predetermined time interval (e.g., period of time) that correspond to the user(s). Likewise, under the pay-per-period payment scheme, the user(s) of ETSN 100 can also provide authorization to the ETSN operator to charge and/or bill the user(s) (e.g., a revolving account, a bank checking account, an e-commerce account from a provider such as PayPal of San Jose, Calif., etc. of the user(s)) of ETSN 100 in the event that the aggregate cost of the respective user(s) for using multiple electricity transfer systems 101 equals and/or exceeds a predetermined cost (e.g., one hundred United States dollars) during the predetermined time interval (e.g., period of time). The predetermined time interval (e.g., period of time) can comprise any suitable period of time (e.g., a day, a week, a month, a year, etc.). In many examples, when the user(s) of ETSN 100 uses multiple electricity transfer systems 101 in the basic member capacity and/or in the premium member capacity, the ETSN operator can receive payment from the user(s) according to the pay-per-period payment scheme.

Further, under the non-payment payment scheme, the user(s) of ETSN 100 can use one or more electricity transfer systems (e.g., electricity transfer system 108) of multiple electricity transfer systems 101 free of charge. In many embodiments, the non-payment payment scheme can be associated with the free user capacity. Similar to as described above with respect to the free user capacity, the host(s) and/or the ETSN operator can be responsible for the costs of transactions conducted according to the non-payment payment scheme. Accordingly, in many embodiments, when the user(s) of ETSN 100 uses multiple electricity transfer systems 101 in the free user capacity and according to the non-payment payment scheme, the ETSN operator can receive payment from the host(s) and/or one or more third parties.

Where applicable, the ETSN operator can charge and/or bill the user(s) of ETSN 100 for taxes and/or other costs associated with using multiple electricity transfer systems 101 as part of the payment schemes. The taxes can comprise any suitable taxes, such as, for example, taxes imposed by a municipality, a county, a state, a country, etc.

Notwithstanding whichever of the payment schemes the ETSN operator uses to receive payment from and/or bill the user(s) of ETSN 100, the ETSN operator can further charge and/or bill the user(s) for use of any electricity transfer system(s) of multiple electricity transfer systems 101 within the payment schemes, according to various user fee structures (e.g., two or more user fee structures, three or more user fee structures, etc.). The two or more user fee structures can correspond to the two or more user capacities, respectively. Likewise, the three or more user fee structures can correspond to the three or more user capacities, respectively. For example, the user fee structures can comprise a guest user fee structure, a basic member user fee structure, and a premium member user fee structure. Other user fee structures can also be associated with the fleet user capacities (e.g., a fleet user fee structure) and/or the free user capacities (e.g., a free user fee structure), and generally speaking, the user fee structures can comprise any suitable and/or desirable user fee structures. In some embodiments, when the user capacity of a user of ETSN 100 cannot be verified, ETSN 100 can default to charging and/or billing the user under the user payment scheme having the lowest transactional cost to the user.

For a particular transaction by a user of ETSN 100 at a given electricity transfer system (e.g., electricity transfer system 108) of multiple electricity transfer systems 101, a first cost to the user(s) if billed according to the premium member user fee structure can be less than a second cost to the user(s) if billed according to the basic member user fee structure. Meanwhile, the second cost to the user(s) can be less than a third cost to the user(s) if billed according to the guest user fee structure. The difference in the transactional costs of using multiple electricity transfer systems 101 in the various user capacities having the associated user fee structures can incentivize user(s) of ETSN 100 to use ETSN 100 and/or multiple electricity transfer systems 101 in the member user capacities and more specifically, in the premium member user capacity. These transactional costs do not include the costs of membership, etc. Further, the free user fee structure can comprise no cost to the user(s) in accordance with the free user capacity and the non-payment payment scheme.

The user fee structures can be assessed, for a given transaction, by the ETSN operator in any suitable manner and/or combinations of manners, such as, for example, (a) charging and/or billing the user(s) of ETSN 100 based on a quantity (e.g., a net quantity) of electricity transferred, where, for example, the electricity transferred can be measured according to the quantity of electric power consumed and/or provided for a unit of time (e.g., kilowatt-hour), (b) charging and/or billing the user(s) of ETSN 100 based on an electric power level of electricity transferred, where, for example, the electric power level can be measured according to the quantity of energy consumed and/or provided per unit of time (e.g., kilowatt), (c) charging and/or billing the user(s) for access to the space approximately adjacent to the electricity transfer system of multiple electricity transfer systems 101, (d) charging and/or billing the user(s) based on the quantity of time the user(s) uses (e.g., the time electricity is transferring) and/or occupies (e.g., the time plugged-in) the electricity transfer system of multiple electricity transfer systems 101, (e) charging and/or billing the user(s) based on transferring electricity to provide a desired percentage (e.g., 50 percent, 75 percent, etc.) of the energy capacity of a total energy capacity of a rechargeable energy storage system (e.g., rechargeable energy storage system 104) of an electric vehicle (e.g., electric vehicle 103), etc. Additionally, the user fee structures can be assessed according to at least charging and/or billing the user(s) based on the quantity of time (e.g., an aggregate quantity of predetermined electricity transfer time intervals) for which the user(s) use and/or occupy the electricity transfer system of multiple electricity transfer systems 101. The electricity metering module of the relevant electricity transfer system of multiple electricity transfer systems 101, the local timing module of the relevant electricity transfer system of multiple electricity transfer systems 101, and/or the master timing module can perform various measurements suitable for assessing the user fee structures.

Regardless of the manner in which the user fee structures are assessed, in some examples, the user fee structures can be applied and/or assessed differently to the user(s) of ETSN 100 depending on the type of electricity transfer system of multiple electricity transfer systems 100 used by the user(s). For example, when the electricity transfer system (e.g., electricity transfer system 108) comprises extended charge electric vehicle supply equipment, the guest user fee structure can comprise an extended charge guest user fee structure; the basic member user fee structure can comprise an extended charge basic member user fee structure; and the premium member user fee structure can comprise an extended charge premium member user fee structure. Meanwhile, when the electricity transfer system (e.g., electricity transfer system 108) comprises the fast charge electric vehicle supply equipment, the guest user fee structure can comprise a fast charge guest user fee structure (e.g., different from the extended charge guest user fee structure); the basic member user fee structure can comprise a fast charge basic member user fee structure (e.g., different from the extended charge basic member user fee structure); and the premium member user fee structure can comprise a fast charge premium member user fee structure (e.g., different from the extended charge premium member user fee structure). These different applications and/or assessments of the user fee structures can be particularly relevant where the user fee structures are assessed according to at least the charging and/or billing the user(s) based on the quantity of time the user(s) use the electricity transfer system of multiple electricity transfer systems 101. That is, use of fast charge electric vehicle supply equipment can be substantially more expensive than use of extended charge electric vehicle supply equipment such that any fast charge user fee structure variant (e.g., the fast charge guest user fee structure) can be more expensive (relative to the amount of time the electric transfer system is used) than a related and/or corresponding extended charge user fee structure variant (e.g., the extended charge guest user fee structure).

Furthermore, in some examples, when the ETSN operator assesses the user fee structures by charging and/or billing the user(s) based on the quantity of time the user(s) uses (e.g., the time electricity is transferring) and/or occupies (e.g., the time plugged-in) the electricity transfer system of multiple electricity transfer systems 101, etc., the quantity of time the user(s) uses the electricity transfer system of multiple electricity transfer systems 101 can be used when the user(s) use the extended charge electric vehicle supply equipment, and the quantity of time the user(s) occupy the electricity transfer system of multiple electricity transfer systems 101 can be used when the user(s) use the fast charge electric vehicle supply equipment. In other examples, the quantity of time the user(s) occupy the electricity transfer system of multiple electricity transfer systems 101 can be used both when the user(s) use the fast charge electric vehicle supply equipment and the extended charge electric vehicle supply equipment.

Likewise, because of the nature of fast charge electric vehicle supply equipment and extended charge electric vehicle supply equipment, the predetermined electricity transfer time intervals used to assess the user fee structure can differ between when a user uses fast charge electric vehicle supply equipment of an electricity transfer system versus extended charge electric vehicle supply equipment of the electricity transfer system or another electricity transfer system. For example, the predetermined electricity transfer time interval for fast charge electric vehicle supply equipment can comprise two-minute time intervals while the predetermined electricity transfer time interval for extended charge electric vehicle supply equipment can comprise one-hour time intervals. Accordingly, the ETSN operator could assess the same cost to the user(s) of ETSN 100 for using the fast charge electric vehicle supply equipment for the predetermined electricity transfer time interval of the fast charge electric vehicle supply equipment as for using the extended charge electric vehicle supply equipment for the predetermined electricity transfer time interval of the extended charge electric vehicle supply equipment for each type/combination of user fee structure variant (e.g., fast charge user fee structure and extended charge user fee structure, etc.).

The ETSN operator can apply grace periods to the predetermined electricity transfer time intervals to mitigate conflict with the user(s) of ETSN 100. For example, if the time which the user(s) of ETSN 100 use and/or occupy an electricity transfer system (e.g., electricity transfer system 108) of multiple electricity transfer systems 101 falls within the specified grace period (e.g., for the particular type of electric vehicle supply equipment), the ETSN operator could spare the user(s) of ETSN 100 from being charged and/or billed for the next additional predetermined electricity transfer time interval. The grace period can comprise any suitable time fraction of the relevant predetermined electricity transfer time interval. The ETSN operator can apply the these grace periods cumulatively for each successive time interval or can reset the grace period after each successive time interval.

The user fee structures can also integrate various discount provisions depending on the particular user fee structure and the related user capacity. For example, under the premium member user fee structure, user(s) of ETSN 100 using ETSN 100 and/or multiple electricity transfer systems 100 in the premium member user capacity can receive electricity credits from the ETSN operator for accumulating a predetermined amount of time of use of multiple electricity transfer systems 100. In a more specific example, the user(s) could be given a free hour of electricity credit after using multiple electricity transfer systems 101 for an aggregate predetermined time of twelve hours.

Where applicable, in line with the payment schemes, any taxes and/or other costs associated with using multiple electricity transfer systems 101 can be included in the user fee structures. Meanwhile, where any electricity transfer system(s) of multiple electricity transfer systems 101 fail to report a user transaction (e.g., due to a disruption of communication module 106) to ETSN computer system 102 within a predetermine quantity of time (e.g., seven days), that user transaction can be voided.

The ETSN operator and/or the host(s) can establish the user fee structures. In some embodiments, the user fee structures can be established for a predetermined time period (e.g., one or more minutes, hours, days, weeks, months, years, etc.). To reduce complication in implementation and to instill confidence in the user(s) of ETSN 100, the ETSN operator can encourage the host(s) to adopt a universal pricing scheme. Nonetheless, in some examples, the user fee structures can differ from one electricity transfer system (e.g., electricity transfer system 108) to another electricity transfer system of multiple electricity transfer systems 101 according to the preferences of the respective hosts.

For example, the host(s) can request host-specific user fee structures to be associated with the various uses capacities. The host(s) may desire to use a non-payment payment scheme to encourage patronage from the user(s) of ETSN 100 at their business(es). In other examples, the host(s) may desire to simply the user fee structures even further by making the user fee structure the same for all user capacities. The host(s) may also desire that their fleet user(s) have to pay less than other user(s) (e.g., guest user(s)) of ETSN 100.

Meanwhile, in some examples, the user fee structures can vary between multiple electricity transfer systems 100. For example, the ETSN operator and/or the host(s) can vary the user fee structures between multiple electricity transfer systems 101 due to one or more regional factors (e.g., regional electricity costs, regional land value, regional site value, regional permitting fees, regional costs of living, etc.). For example, different user fee structures can be implemented to offset increased operational costs resulting from the regional factor(s). It follows that multiple electricity transfer systems 101 can be located in multiple regions (e.g., municipal blocks, municipalities, counties/parishes, states/provinces, countries, etc.). In further examples, the ETSN operator and/or the host(s) can vary the user fee structures between multiple electricity transfer systems 101 due to one or more other suitable factors, such as, for example, demand for each electricity transfer system of multiple electricity transfer systems 101 (e.g., the cost for using a higher demand or more popular electricity transfer system can be higher).

As mentioned previously, the ETSN operator can provide one or more host incentives to the host(s) of multiple electricity transfer systems 101 in exchange for affiliating with ETSN 100. Many examples of host incentive(s) that can be provided by the ETSN operator have already been discussed previously above. However, to reiterate and expand on the host incentive(s), some examples of the host incentive(s) can comprise providing business and/or recognition to host(s) through affiliation with ETSN 100, permitting the ETSN operator and/or the host to establish operation time parameters (e.g., times/days of operation) of the electricity transfer system(s) (e.g., of multiple electricity transfer systems 101) of the relevant host(s), permitting the host(s) to establish user capacities (e.g., fleet user capacities) and/or user fee structures for using the electricity transfer system(s) (e.g., of multiple electricity transfer systems 101) of the relevant host(s), permitting the host(s) to establish whether the electricity transfer system(s) (e.g., of multiple electricity transfer systems 101) of the relevant host(s) can be reserved and if so, under what conditions, etc. In some embodiments, where the host(s) are permitted to establish the user capacities and/or user fee structures, additional fees can be assessed on the host(s) by the ETSN operator to offset increases in administration costs occurring from non-standardized operation of the electricity transfer system(s) (e.g., of multiple electricity transfer systems 101) of the host(s).

Meanwhile, in these or other examples, the host incentive(s) can also comprise revenue sharing (e.g., a percentage of revenue) by the ETSN operator with at least the host(s). For example, the ETSN operator can share with the host(s) a percentage (e.g., 50 percent) of any revenue generated via use of the electricity transfer system(s) (e.g., of multiple electricity transfer systems 101) of the host(s) by the user(s) of ETSN 100. Such revenue can be shared differently depending on whether the user(s) use the electricity transfer system(s) (e.g., of multiple electricity transfer systems 101) of the host(s) as extended charge electric vehicle supply equipment versus fast charge electric vehicle supply equipment. In these or other examples, the revenue sharing can also comprise sharing revenue from providing third-party data (e.g., marketing data) to the user(s) of ETSN 100 and/or multiple electricity transfer systems 101, from reservation fees and/or penalties assessed for the electricity transfer system(s) (e.g., of multiple electricity transfer systems 101) of the host(s), etc. Where the revenue sharing comprises sharing revenue from reservation penalties, a first percentage (e.g., fifty percent) can be provided to any inconvenienced user of ETSN 100 having been unable to make use of his reservation, a second percentage (e.g., twenty-five percent) can be paid to the host of the reserved electricity transfer system of multiple electricity transfer systems 101, and a third percentage can remain with the ETSN operator. The host(s) can also be provided a periodic monetary offset (e.g., monthly) for hosting electricity transfer system(s) (e.g., of multiple electricity transfer systems 101) with fast charge electric vehicle supply equipment. The revenue sharing can also be provided and/or distributed to the host(s) on a periodic basis (e.g., monthly, quarterly, etc.).

In these or other examples, the host incentive(s) can comprise the third-party data provided to the user where the third-party data comprises host advertisement data. The host(s) can also be permitted to select some or all of the third-party data presented to the user(s) as a related and/or further host incentive. In some examples, the host advertisement data can be presented via the body, frame, and/or chassis of the electricity transfer system(s) (e.g., of multiple electricity transfer systems 101) of the host(s), as described above, in addition to and/or in the alternative to third-party data that is presented to the user(s) of ETSN 100 electronically.

Furthermore, the host incentive(s) can also comprise one or more host coupons provided to the user by the ETSN operator. The host coupon(s) can be provided in tandem with host advertisement data and/or separately. The host coupon(s) be provided to any user(s) and/or specific user(s) of ETSN 100, as desirable. The ETSN operator can also provide electricity transfer credits, as described below, on behalf of the host(s), for which the host(s) can reimburse the ETSN operator.

Additionally, the host incentive(s) can also comprise one or more programs encouraging dialogue between the user and the host. For example, the program(s) can comprise providing thank you cards to the user(s) to provide to the host(s), reports on user habit data of the user(s) of ETSN 100 to determine desirable locations to provide electricity transfer system(s) of multiple electricity transfer systems 101, forums to receive requests from the user(s) of ETSN 100 for locations to provide electricity transfer system(s) of multiple electricity transfer systems 101, reports indicating need for additional electric transfer system(s) of multiple electricity transfer systems 101, etc.

Further still, the host incentive(s) can comprise access to usage data corresponding to the user(s) of ETSN 100, such as, for example, in the form of reports, articles, white papers, etc. The reports, articles, white papers, etc. can be edited and/or tailored to reflect the interests of the host(s) and/or can be provided on a period basis (e.g., monthly, quarterly, annually, etc.). Specific data and/or analyses can also be requested by the host(s) and performed by the ETSN operator using usage data from the user(s) of ETSN 100. Such access to usage data can be particularly relevant where user(s) of ETSN 100 use the electricity transfer system(s) (e.g., of multiple electricity transfer systems 101) of the host(s) in one or more of the fleet user capacities and can help the host(s) to track and/or manage their fleet(s). The ETSN operator can also provide systems for helping the host(s) to manage a queue of their fleet(s) using the usage data.

As a general matter, but in what can also provide host incentive(s) to the host(s), the ETSN operator can also maintain the electricity transfer system(s) (e.g., of multiple electricity transfer systems 101) of the host(s), provide firmware and/or software upgrades for the electricity transfer system(s) (e.g., of multiple electricity transfer systems 101) of the host(s), provide equipment upgrades for the electricity transfer system(s) (e.g., of multiple electricity transfer systems 101) of the host(s), provide technical support to the host(s) and/or user(s) of ETSN 100, providing accounting administration to the host(s), etc.

Meanwhile, the ETSN operator can also provide one or more member user incentives to the user(s) of ETSN 100 in exchange for using multiple electricity transfer systems 100 in one or more of the member user capacities (e.g., the basic member user capacity, the premium member user capacity, etc.). In one example of a member user incentive, as described above, member user(s) can be permitted to use multiple electricity transfer systems 101 with discounted pricing schemes. As also provided previously, these discounts can increase for differing member user capacities. In some embodiments, the host(s) of ETSN 100 can be reimbursed by the ETSN operator for these discounts. Also, the member user(s) can receive electricity transfer credits (e.g., redeemable via the member user profile(s)) based on cumulative use of multiple electricity transfer systems 101, as described above. The member user(s) can aggregate these electricity transfer credits as additional electricity transfer credits are awarded to the member user(s) by the ETSN operator. In other examples of member user incentive(s), member user(s) can be permitted to reserve the electricity transfer system(s) of multiple electricity transfer systems 101 for the future use. The capability to make such reservations can be exclusive to member user(s) or in some examples, the member user(s) can just be given preference over user(s) that use ETSN 100 and/or multiple electricity transfer systems 101 in other user capacities. In further examples of member user incentive(s), member user(s) can be permitted to use ETSN 100 and/or multiple electricity transfer systems 101 without being subjected to having to view third-party data in the form of marketing data or having to view less third-party data in the form of marketing data, whether at all or before being able to begin charging an electric vehicle and/or a rechargeable energy storage system. In still further examples of member user incentive(s), member user(s) can be provided with access to their usage data for review and analysis. In some examples, the ETSN operator can also provide access to articles, white papers, etc. created from usage data aggregated by the ETSN operator, as described above. The member incentive(s) can also comprise access to one or more user electronic forums (e.g., via the Internet portal of the ETSN operator) and/or one or more events (e.g., meetings, rallies, and other special gatherings) permitting the user to communicate with the one or more other users of the electricity transfer system network.

In addition to the above described member user incentives, which might be thought of more as static member user incentive(s), the ETSN operator can also provide dynamic member user incentive(s) to the member user(s). That is, member user incentive(s) that can be provided by the ETSN operator on an unpredictable and/or discontinuous basis. For example, the ETSN operator can award (a) one or more electricity transfer credits (e.g., as virtual currency to be used with ETSN 100), (b) one or more electricity transfer coupons (e.g., providing discounted use of multiple electricity transfer systems 101), (c) one or more third-party coupons (e.g., providing discounts for third-party and/or host businesses/operations), etc.

Furthermore, the member incentive(s) can comprise access to one or more events (e.g., games, contests, etc.) providing one or more opportunities for discounted or free use of ETSN 100 and/or multiple electricity transfer systems 101 (e.g., electricity transfer system 108) to the user, such as, for example, at the electricity transfer system(s) in one or more certain locations and/or of one or more certain hosts. The ETSN operator can also provide any the electricity transfer credit(s), the electricity transfer coupon(s), the third-party coupon(s), as well as any other suitable merchandise (e.g., free apparel, etc.) at these events. In some examples, third parties, such as, for example, electric vehicle original equipment manufacturers, can also participate in the events. Meanwhile, the ETSN operator can also benefit from the event(s) by using the event(s) to determine location(s) of preferred electricity transfer system(s) of multiple electricity transfer systems 101, to compare usage patterns between multiple electric transfer systems 101, to determine the relative convenience and/or accessibility to the user(s) of multiple electric transfer systems 101, to determine new locations at which to locate new electricity transfer systems to add to multiple electric transfer systems 101, etc.

Additional member user incentive(s) can also comprise any of the support and/or services provided by the ETSN operator that is/are described above. In some embodiments, one or more of the host incentive(s) can also comprise member user incentive(s), and vice versa.

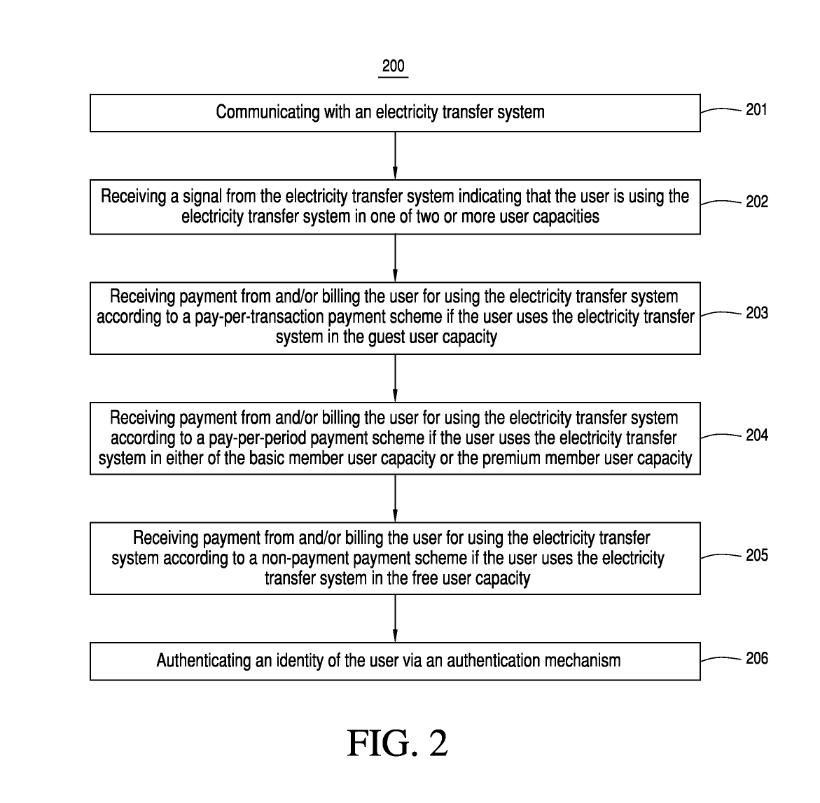

Turning to the next drawing, FIG. 2 illustrates a flow chart for an embodiment of method 200 of operating (a) an electricity transfer system network (ETSN) computer system of an electricity transfer system network (ETSN) and/or (b) an application programmable interface related thereto. In many embodiments, the application programmable interface can be configured to communicate with the ETSN computer system, one or more cloud computer systems, one or more third-party resource computer systems, and/or one or more personal computer systems. Further, at least part of method 200 can be implemented via execution of computer instructions configured to run at one or more processing modules and configured to be stored at one or more memory storage modules of the ETSN computer system, the cloud computer system(s), the third-party resource computer system(s), and/or the personal computer system(s). Method 200 is merely exemplary and is not limited to the embodiments presented herein. Method 200 can be employed in many different embodiments or examples not specifically depicted or described herein. In some embodiments, the procedures, the processes, and/or the activities of method 200 can be performed in the order presented. In other embodiments, the procedures, the processes, and/or the activities of method 200 can be performed in any other suitable order. In still other embodiments, one or more of the procedures, the processes, and/or the activities in method 200 can be combined or skipped. The ETSN can be similar or identical to ETSN 100 (FIG. 1); the ETSN computer system can be similar or identical to ETSN 102 (FIG. 1); the cloud computer system(s) can be similar or identical to the cloud computer system(s) described above with respect to ETSN 100 (FIG. 1); the third-party resource computer system(s) can be similar or identical to the third-party resource computer system(s) described above with respect to ETSN 100 (FIG. 1); and/or the personal computer system(s) can be similar or identical to the personal computer system(s) described above with respect to ETSN 100 (FIG. 1).

Method 200 can comprise procedure 201 of communicating with an electricity transfer system, such as, for example, with a communication module. The electricity transfer system can be similar or identical to any of multiple electricity transfer systems 101 (e.g., electricity transfer system 108), and the communication module can be similar or identical to communication module 106 (FIG. 1).

Method 200 can comprise procedure 202 of receiving a signal from the electricity transfer system indicating that the user is using the electricity transfer system in one of two or more user capacities. The user capacities can be similar or identical to the user capacities described above with respect to ETSN 100 (FIG. 1). For example, the two or more user capacities can comprise at least two of a guest user capacity, a first-tier (e.g., basic) member user capacity, a second-tier (e.g., premium) member user capacity, a free user capacity, and/or a fleet user capacity. In many embodiments, procedure 202 can be repeated one or more times. Furthermore, in many embodiments, procedure 202 can be performed after procedure 201.

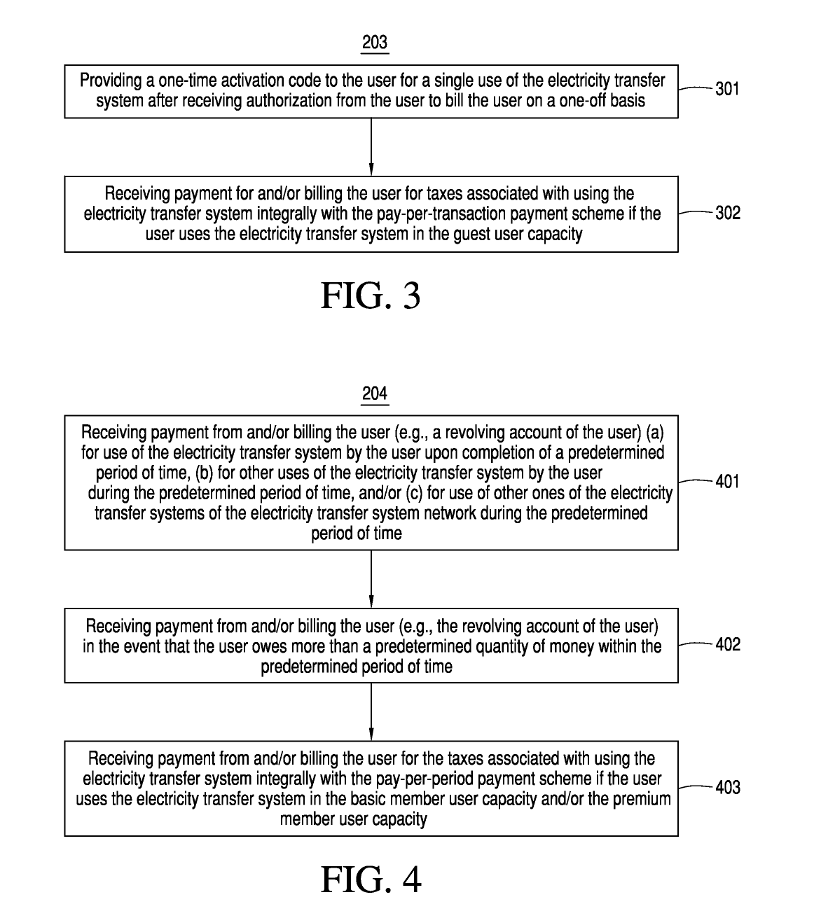

Method 200 can comprise procedure 203 of receiving payment from and/or billing the user for using the electricity transfer system according to a pay-per-transaction payment scheme if the user uses the electricity transfer system in the guest user capacity. The pay-per-transaction payment scheme can be similar or identical to the pay-per-transaction payment scheme described above with respect to ETSN 100 (FIG. 1). In some embodiments, procedure 203 can be omitted. In various embodiments, procedure 203 can be performed after procedure 202. In many embodiments, procedure 203 can be repeated one or more times. FIG. 3 illustrates an exemplary procedure 203.

Turning now to FIG. 3, procedure 203 can comprise process 301 of providing a one-time activation code to the user for a single use of the electricity transfer system after receiving authorization from the user to bill the user on a one-off basis. Process 301 can be performed in a manner to that described above with respect to the pay-per-transaction payment scheme of ETSN 100 (FIG. 1).

Procedure 203 can also comprise process 302 of receiving payment for and/or billing the user for taxes associated with using the electricity transfer system integrally with the pay-per-transaction payment scheme if the user uses the electricity transfer system in the guest user capacity. Process 302 can be performed in a manner similar to that described above with respect to the pay-per-transaction payment scheme of ETSN 100 (FIG. 1). In some embodiments, process 302 can be omitted.

Returning to FIG. 2, method 200 can further comprise procedure 204 of receiving payment from and/or billing the user for using the electricity transfer system according to a pay-per-period payment scheme if the user uses the electricity transfer system in either of the basic member user capacity or the premium member user capacity. The pay-per-period payment scheme can be similar or identical to the pay-per-period payment scheme described above with respect to ETSN 100 (FIG. 1). In some embodiments, procedure 204 can be omitted. In many embodiments, procedure 204 can be performed after procedure 202. Furthermore, in many embodiments, procedure 204 can be repeated one or more times. FIG. 4 illustrates an exemplary procedure 204.

Turning ahead to FIG. 4, procedure 204 can comprise process 401 of receiving payment from and/or billing the user (e.g., a revolving account of the user) (a) for use of the electricity transfer system by the user upon completion of a predetermined period of time, (b) for other uses of the electricity transfer system by the user during the predetermined period of time, and/or (c) for use of other ones of the electricity transfer systems of the electricity transfer system network during the predetermined period of time. Process 401 can be performed in a manner similar to that described above with respect to the pay-per-period payment scheme of ETSN 100 (FIG. 1). Likewise, the predetermined period of time can be similar or identical to the predetermined period of time described above with respect to the pay-per-period payment scheme of ETSN 100 (FIG. 1).

Procedure 204 can also comprise process 402 of receiving payment from and/or billing the user (e.g., the revolving account of the user) in the event that the user owes more than a predetermined quantity of money within the predetermined period of time. Process 401 can be performed in a manner similar to that described above with respect to the pay-per-period payment scheme of ETSN 100 (FIG. 1). Likewise, the predetermined quantity of money can be similar or identical to the predetermined quantity of money described above with respect to the pay-per-period payment scheme of ETSN 100 (FIG. 1).

Procedure 204 can further comprise process 403 of receiving payment from and/or billing the user for the taxes associated with using the electricity transfer system integrally with the pay-per-period payment scheme if the user uses the electricity transfer system in the basic member user capacity and/or the premium member user capacity. Process 403 can be performed in a manner similar to that described above with respect to the pay-per-period payment scheme of ETSN 100 (FIG. 1). In some embodiments, process 403 can be omitted.

Turning back again to FIG. 2, method 200 can further comprise procedure 205 of receiving payment from and/or billing the user for using the electricity transfer system according to a non-payment payment scheme if the user uses the electricity transfer system in the free user capacity.

Turning back again to FIG. 2, method 200 can comprise procedure 206 of authenticating an identity of the user via an authentication mechanism. The authentication mechanism can be similar or identical to authentication mechanism 105 (FIG. 1). Furthermore, procedure 205 can be performed in similar manner to authenticating the identity of the user via the authentication mechanism as described above with respect to ETSN 100 (FIG. 1). In many embodiments, procedure 205 can be performed after procedure 202.

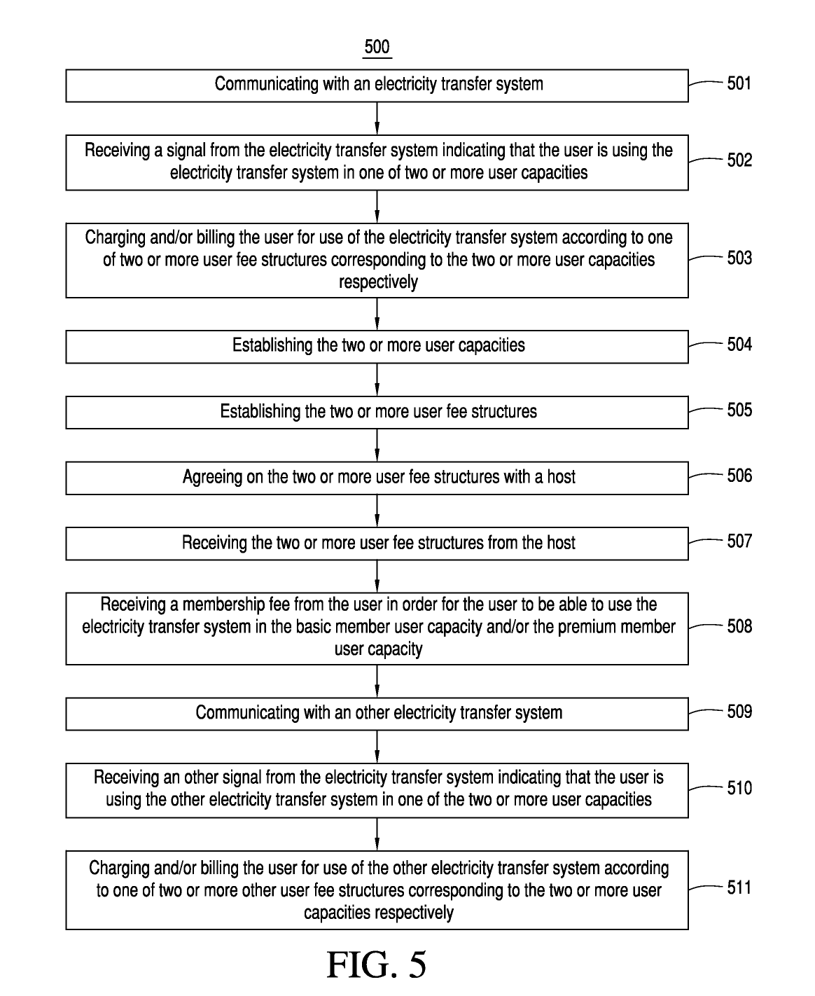

Skipping ahead in the drawings, FIG. 5 illustrates a flow chart for an embodiment of method 500 of operating (a) an electricity transfer system network (ETSN) computer system of an electricity transfer system network (ETSN) and/or (b) an application programmable interface related thereto. In many embodiments, the application programmable interface can be configured to communicate with the ETSN computer system, one or more cloud computer systems, one or more third-party resource computer systems, and/or one or more personal computer systems. Further, at least part of method 500 can be implemented via execution of computer instructions configured to run at one or more processing modules and configured to be stored at one or more memory storage modules of the ETSN computer system, the cloud computer system(s), the third-party resource computer system(s), and/or the personal computer system(s). Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any other suitable order. In still other embodiments, one or more of the procedures, the processes, and/or the activities in method 500 can be combined or skipped. The ETSN can be similar or identical to ETSN 100 (FIG. 1); the ETSN computer system can be similar or identical to ETSN 102 (FIG. 1); the cloud computer system(s) can be similar or identical to the cloud computer system(s) described above with respect to ETSN 100 (FIG. 1); the third-party resource computer system(s) can be similar or identical to the third-party resource computer system(s) described above with respect to ETSN 100 (FIG. 1); and/or the personal computer system(s) can be similar or identical to the personal computer system(s) described above with respect to ETSN 100 (FIG. 1).

Method 500 can comprise procedure 501 of communicating with an electricity transfer system, such as, for example, with a communication module. The electricity transfer system can be similar or identical to any of multiple electricity transfer systems 101 (e.g., electricity transfer system 108), and the communication module can be similar or identical to communication module 106 (FIG. 1). In many embodiments, performing procedure 501 can comprise communicating with an extended charge electric vehicle supply equipment and/or a fast charge electric vehicle supply equipment. The extended charge electric vehicle supply equipment and/or the fast charge electric vehicle supply equipment can be similar or identical to the extended charge electric vehicle supply equipment and/or the fast charge electric vehicle supply equipment described above with respect to ETSN 100 (FIG. 1).

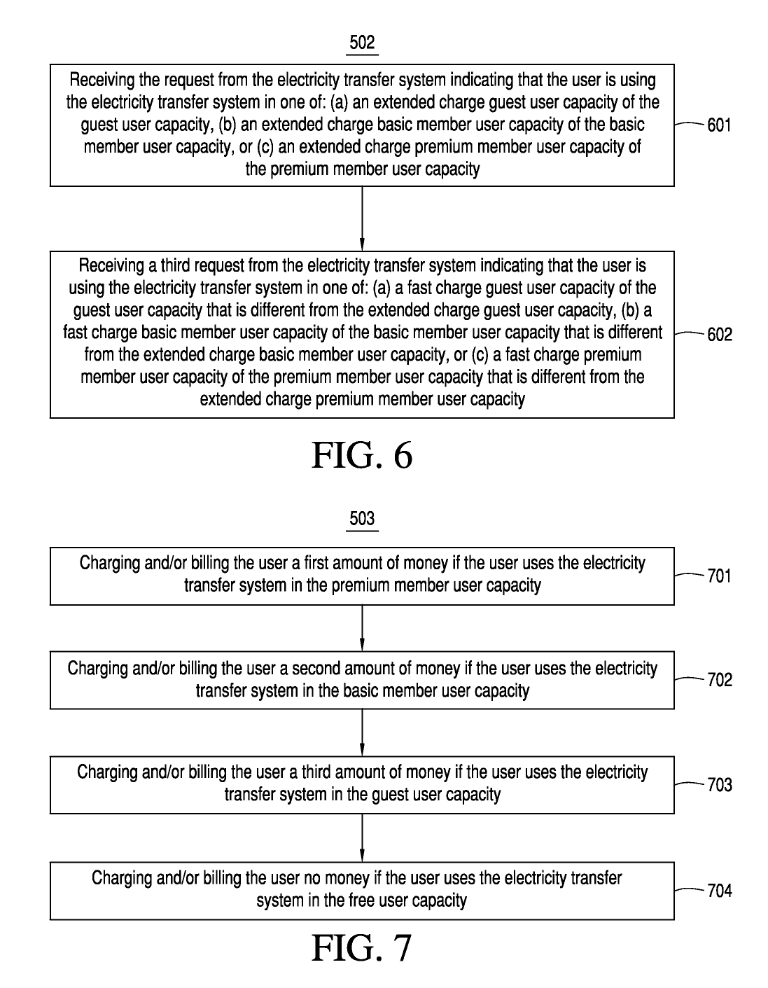

Method 500 can also comprise procedure 502 of receiving a signal from the electricity transfer system indicating that the user is using the electricity transfer system in one of two or more user capacities. The user capacities can be similar or identical to the user capacities described above with respect to ETSN 100 (FIG. 1). For example, the two or more user capacities can comprise at least two of a guest user capacity, a first-tier (e.g., basic) member user capacity, a second-tier (e.g., premium) member user capacity, a free user capacity, and/or a fleet user capacity. In many embodiments, procedure 502 can be repeated one or more times. Furthermore, in many embodiments, procedure 502 can be performed after procedure 501. FIG. 6 illustrates an exemplary procedure 502.

Referring to FIG. 6, procedure 502 can comprise process 601 of receiving the request from the electricity transfer system indicating that the user is using the electricity transfer system in one of: (a) an extended charge guest user capacity of the guest user capacity, (b) an extended charge basic member user capacity of the basic member user capacity, or (c) an extended charge premium member user capacity of the premium member user capacity. In many embodiments, process 601 can be performed when the electricity transfer system comprises the extended charge electric vehicle supply equipment. In some embodiments, process 601 can be omitted. The extended charge guest user capacity can be similar or identical to the extended charge guest user capacity described above with respect to ETSN 100 (FIG. 1); the extended charge basic member user capacity can be similar or identical to the extended charge basic member user capacity described above with respect to ETSN 100 (FIG. 1); and/or the extended charge premium member user capacity can be similar or identical to the extended charge premium member user capacity described above with respect to ETSN 100 (FIG. 1).

In these or other embodiments, procedure 502 can also comprise process 602 of receiving a third request from the electricity transfer system indicating that the user is using the electricity transfer system in one of: (a) a fast charge guest user capacity of the guest user capacity that is different from the extended charge guest user capacity, (b) a fast charge basic member user capacity of the basic member user capacity that is different from the extended charge basic member user capacity, or (c) a fast charge premium member user capacity of the premium member user capacity that is different from the extended charge premium member user capacity. In many embodiments, process 602 can be performed when the electricity transfer system comprises the fast charge electric vehicle supply equipment. In some embodiments, process 602 can be omitted. The fast charge guest user capacity can be similar or identical to the fast charge guest user capacity described above with respect to ETSN 100 (FIG. 1); the fast charge basic member user capacity can be similar or identical to the fast charge basic member user capacity described above with respect to ETSN 100 (FIG. 1); and/or the fast charge premium member user capacity can be similar or identical to the fast charge premium member user capacity described above with respect to ETSN 100 (FIG. 1).

Returning to FIG. 5, method 500 can further comprise procedure 503 of charging and/or billing the user for use of the electricity transfer system according to one of two or more user fee structures corresponding to the two or more user capacities respectively. The user fee structures can be similar or identical to the user fee structures described above with respect to ETSN 100 (FIG. 1). For example, the user fee structures can comprise at least two of a guest user fee structure, a basic member user fee structure, a premium member user fee structure, or a free user fee structure. In many embodiments, procedure 503 can be performed after procedure 502. Furthermore, in many embodiments, procedure 503 can be repeated one or more times. FIG. 7 illustrates an exemplary procedure 503.

Turning ahead to FIG. 7, procedure 503 can comprise process 701 of charging and/or billing the user a first amount of money if the user uses the electricity transfer system in the premium member user capacity. Where process 701 is performed, process 702, process 703, and/or process 704 can be omitted. In some embodiments, procedure 701 can further comprise sharing at least part of the first amount of money with at least a host of the electricity transfer system.

Procedure 503 can also comprise process 702 of charging and/or billing the user a second amount of money if the user uses the electricity transfer system in the basic member user capacity. The second amount of money can be greater than the first amount of money. Where process 702 is performed, process 701, process 703, and/or process 704 can be omitted. In some embodiments, procedure 702 can further comprise sharing at least part of the second amount of money with at least the host of the electricity transfer system.

Procedure 503 can further comprise procedure 703 of charging and/or billing the user a third amount of money if the user uses the electricity transfer system in the guest user capacity. The third amount of money can be greater than the second amount of money. Where process 703 is performed, process 701, process 702, and/or process 704 can be omitted. In some embodiments, procedure 703 can further comprise sharing at least part of the third amount of money with at least the host of the electricity transfer system.

Procedure 503 can further comprise procedure 704 of charging and/or billing the user no money if the user uses the electricity transfer system in the free user capacity. When process 704 is performed, process 701, process 702, and/or process 703 can be omitted. In some embodiments, procedure 704 can further comprise charging and/or billing the host of the electricity transfer system a fourth amount of money if the user uses the electricity transfer system in the free user capacity.

Turning back to FIG. 5, method 500 can additionally comprise procedure 504 of establishing the two or more user capacities. In many embodiments, procedure 504 can be performed before procedures 501, 502, and/or 503.

Method 500 can also comprise procedure 505 of establishing the two or more user fee structures. In many embodiments, procedure 505 can be performed before procedures 501, 502, and/or 503. Where process 505 is performed, process 506 and/or process 507 can be omitted.

Method 500 can further comprise procedure 506 of agreeing on the two or more user fee structures with a host. In many embodiments, procedure 506 can be performed before procedures 501, 502, and/or 503. Where process 506 is performed, process 505 and/or process 507 can be omitted. The host can be similar or identical to the host described above with respect to ETSN 100 (FIG. 1).

Method 500 can additionally comprise procedure 507 of receiving the two or more user fee structures from the host. In many embodiments, procedure 507 can be performed before procedures 501, 502, and/or 503. Where process 507 is performed, process 505 and/or process 506 can be omitted.

Method 500 can also comprise procedure 508 of receiving a membership fee from the user in order for the user to be able to use the electricity transfer system in the basic member user capacity and/or the premium member user capacity. Performing procedure 508 can comprise receiving an upfront membership fee and/or an annual membership fee. The membership fee can be similar or identical to the membership fee described above with respect to ETSN 100 (FIG. 1). In some embodiments, procedure 508 can further comprise sharing at least part of the membership fee with at least the host of the electricity transfer system.

Method 500 can further comprise procedure 509 of communicating with an other electricity transfer system, such as, for example, with the communication module. The other electricity transfer system can be similar or identical to any of multiple electricity transfer systems 101 (e.g., electricity transfer system 108). In some embodiments, procedure 509 can be omitted.

Method 500 can additionally comprise procedure 510 of receiving an other signal from the electricity transfer system indicating that the user is using the other electricity transfer system in one of the two or more user capacities. In some embodiments, procedure 510 can be omitted. In many embodiments, procedure 510 can be performed after procedure 509.

Method 500 can comprise procedure 511 of charging and/or billing the user for use of the other electricity transfer system according to one of two or more other user fee structures corresponding to the two or more user capacities respectively. The two or more other user fee structures can comprise at least two of an other guest user fee structure, an other basic member user fee structure, an other premium member user fee structure, and/or the free user fee structure, and each of the guest user fee structure, the basic member user fee structure, and the premium member user fee structure differing from the other guest user fee structure, the other basic member user fee structure, and the other premium member user fee structure, respectively, according to (a) at least one regional factor and/or (b) at least one host preference. The regional factor(s) can be similar or identical to the regional factor(s) described above with respect to ETSN 100 (FIG. 1). Meanwhile, the host preference(s) can be similar or identical to the host preference(s) described above with respect to ETSN 100 (FIG. 1). In some embodiments, procedure 511 can be omitted. In many embodiments, procedure 511 can be performed after procedure 510.

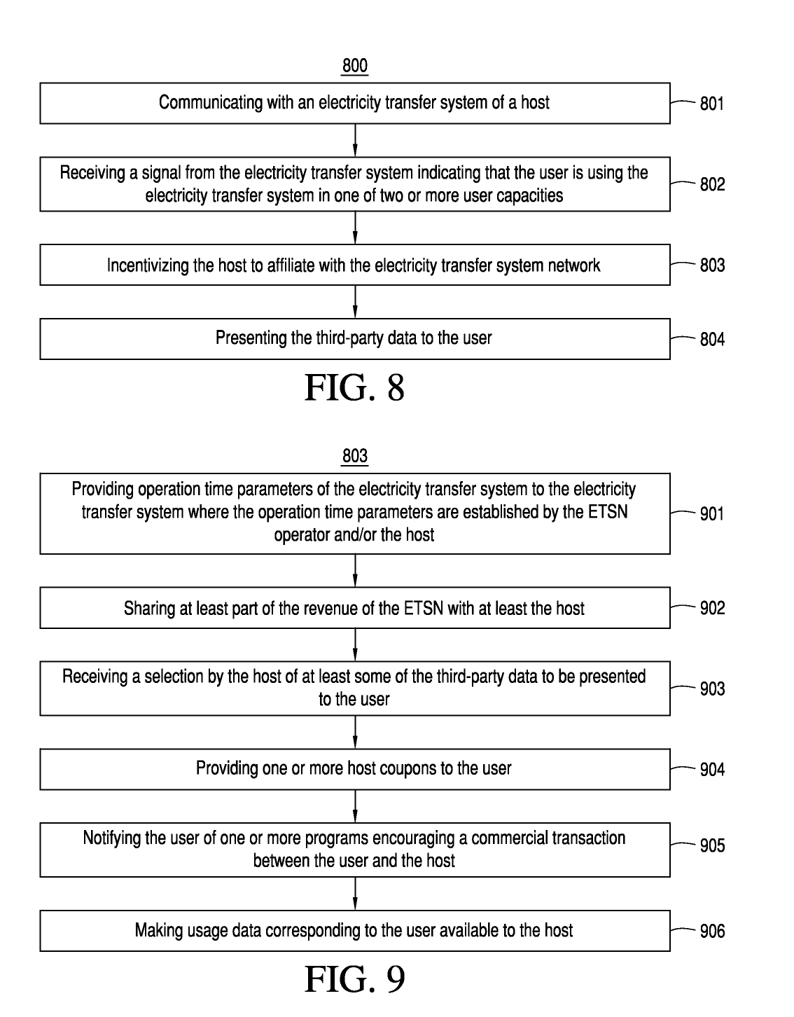

Turning to a subsequent drawing, FIG. 8 illustrates a flow chart for an embodiment of method 800 of operating (a) an electricity transfer system network (ETSN) computer system of an electricity transfer system network (ETSN) and/or (b) an application programmable interface related thereto. In many embodiments, the application programmable interface can be configured to communicate with the ETSN computer system, one or more cloud computer systems, one or more third-party resource computer systems, and/or one or more personal computer systems. Further, at least part of method 800 can be implemented via execution of computer instructions configured to run at one or more processing modules and configured to be stored at one or more memory storage modules of the ETSN computer system, the cloud computer system(s), the third-party resource computer system(s), and/or the personal computer system(s). Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any other suitable order. In still other embodiments, one or more of the procedures, the processes, and/or the activities in method 800 can be combined or skipped. The ETSN can be similar or identical to ETSN 100 (FIG. 1); the ETSN computer system can be similar or identical to ETSN 102 (FIG. 1); the cloud computer system(s) can be similar or identical to the cloud computer system(s) described above with respect to ETSN 100 (FIG. 1); the third-party resource computer system(s) can be similar or identical to the third-party resource computer system(s) described above with respect to ETSN 100 (FIG. 1); and/or the personal computer system(s) can be similar or identical to the personal computer system(s) described above with respect to ETSN 100 (FIG. 1).

Method 800 can also comprise procedure 801 of communicating with an electricity transfer system of a host, such as, for example, with a communication module. The electricity transfer system can be similar or identical to any of multiple electricity transfer systems 101 (e.g., electricity transfer system 108), and the communication module can be similar or identical to communication module 106 (FIG. 1). Meanwhile, the host can be similar or identical to the host(s) described above with respect to ETSN 100 (FIG. 1).

Method 800 can further comprise procedure 802 of receiving a signal from the electricity transfer system indicating that the user is using the electricity transfer system in one of two or more user capacities. The user capacities can be similar or identical to the user capacities described above with respect to ETSN 100 (FIG. 1). For example, the two or more user capacities can comprise a guest user capacity, a first-tier (e.g., basic) member user capacity, a second-tier (e.g., premium) member user capacity, a free user capacity, and/or a fleet user capacity. In many embodiments, procedure 802 can be repeated one or more times. Furthermore, in many embodiments, procedure 802 can be performed after procedure 801.

Method 800 can additionally comprise procedure 803 of incentivizing the host to affiliate with the electricity transfer system network. In some embodiments, performing procedure 803 can comprise performing procedure 802 where the two or more user capacities further comprise one or more fleet user capacities and/or a free user capacity. The fleet user capacities can be similar or identical to the fleet user capacities described above with respect to ETSN 100 (FIG. 1), and the free user capacity can be similar or identical to the free user capacity described above with respect to ETSN 100 (FIG. 1). In other embodiments, performing procedure 803 can comprise performing procedure 804 (below), such as, for example, where the third-party data comprises host advertisement data. The third-party data can be similar or identical to the third-party data described above with respect to ETSN 100 (FIG. 1), and the host advertisement data can be similar or identical to the host advertisement data described above with respect to ETSN 100 (FIG. 1). FIG. 9 illustrates an exemplary procedure 803. The processes of exemplary procedure 803 can be performed in any sequence.

Procedure 803 can comprise process 901 of providing operation time parameters of the electricity transfer system to the electricity transfer system where the operation time parameters are established by the ETSN operator and/or the host. The operation time parameters of the electricity transfer system can be similar or identical to the operation time parameters of the electricity transfer system as described above with respect to ETSN 100 (FIG. 1).

Procedure 803 can also comprise process 902 of sharing at least part of the revenue of the ETSN with at least the host. Performing process 902 can be similar to sharing at least part of the revenue of the ETSN with at least the host as described above with respect to ETSN 100 (FIG. 1).

Procedure 803 can further comprise process 903 of receiving a selection by the host of at least some of the third-party data to be presented to the user, such as, for example, via procedure 804 (below). Performing process 903 can be similar to receiving the selection by the host of at least some of the third-party data to be presented to the user as described above with respect to ETSN 100 (FIG. 1).

Procedure 803 can still further comprise process 904 of providing one or more host coupons to the user. The host coupons can be similar or identical to the host coupons described above with respect to ETSN 100 (FIG. 1).

Procedure 803 can additionally comprise process 905 of notifying the user of one or more programs encouraging a commercial transaction between the user and the host. The programs encouraging dialogue between the user and the host can be similar or identical to the programs encouraging dialogue between the user and the host described above with respect to ETSN 100 (FIG. 1).

Procedure 803 can also comprise process 906 of making usage data corresponding to the user available to the host. The usage data can be similar or identical to the usage data described above with respect to ETSN 100 (FIG. 1).

Returning to FIG. 8, method 800 can comprise procedure 804 of presenting the third-party data to the user. In some embodiments, procedure 804 can be omitted. In further embodiments, procedure 804 can be repeated one or more times.

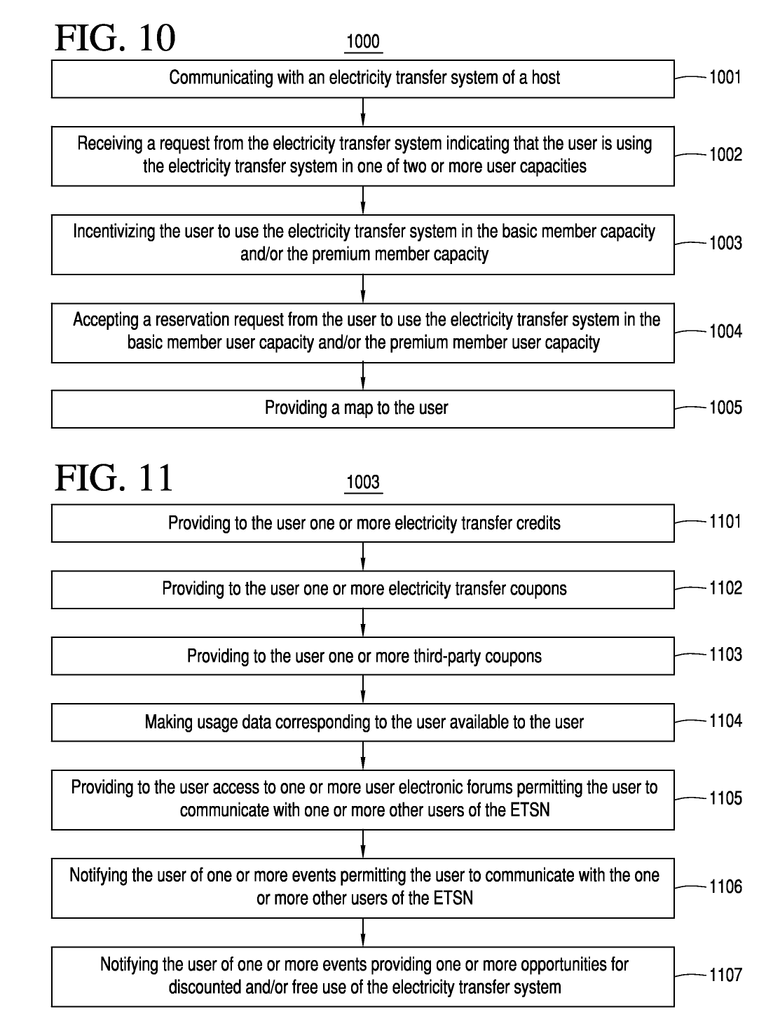

Turning to the next drawing, FIG. 10 illustrates a flow chart for an embodiment of method 1000 of operating (a) an electricity transfer system network (ETSN) computer system of an electricity transfer system network (ETSN) and/or (b) an application programmable interface related thereto. In many embodiments, the application programmable interface can be configured to communicate with the ETSN computer system, one or more cloud computer systems, one or more third-party resource computer systems, and/or one or more personal computer systems. Further, at least part of method 1000 can be implemented via execution of computer instructions configured to run at one or more processing modules and configured to be stored at one or more memory storage modules of the ETSN computer system, the cloud computer system(s), the third-party resource computer system(s), and/or the personal computer system(s). Method 1000 is merely exemplary and is not limited to the embodiments presented herein. Method 1000 can be employed in many different embodiments or examples not specifically depicted or described herein. In some embodiments, the procedures, the processes, and/or the activities of method 1000 can be performed in the order presented. In other embodiments, the procedures, the processes, and/or the activities of method 1000 can be performed in any other suitable order. In still other embodiments, one or more of the procedures, the processes, and/or the activities in method 1000 can be combined or skipped. The ETSN can be similar or identical to ETSN 100 (FIG. 1); the ETSN computer system can be similar or identical to ETSN 102 (FIG. 1); the cloud computer system(s) can be similar or identical to the cloud computer system(s) described above with respect to ETSN 100 (FIG. 1); the third-party resource computer system(s) can be similar or identical to the third-party resource computer system(s) described above with respect to ETSN 100 (FIG. 1); and/or the personal computer system(s) can be similar or identical to the personal computer system(s) described above with respect to ETSN 100 (FIG. 1).

Method 1000 can comprise procedure 1001 of communicating with an electricity transfer system of a host, such as, for example, with a communication module. The electricity transfer system can be similar or identical to any of multiple electricity transfer systems 101 (e.g., electricity transfer system 108), and the communication module can be similar or identical to communication module 106 (FIG. 1). Meanwhile, the host can be similar or identical to the host(s) described above with respect to ETSN 100 (FIG. 1).

Method 1000 can also comprise procedure 1002 of receiving a request from the electricity transfer system indicating that the user is using the electricity transfer system in one of two or more user capacities. The user capacities can be similar or identical to the user capacities described above with respect to ETSN 100 (FIG. 1). For example, the two or more user capacities can comprise at least one of a guest user capacity, a first-tier (e.g., basic) member user capacity, a second-tier (e.g., premium) member user capacity, a free user capacity, and/or a fleet user capacity. In many embodiments, procedure 1002 can be repeated one or more times. Furthermore, in many embodiments, procedure 1002 can be performed after procedure 1001.

Method 1000 can further comprise procedure 1003 of incentivizing the user to use the electricity transfer system in the basic member capacity and/or the premium member capacity. In some embodiments, performing procedure 1003 can comprise performing procedure 1004 and/or procedure 1005 (below). FIG. 11 illustrates an exemplary procedure 1003. The processes of exemplary procedure 1003 can be performed in any sequence.

Turning to FIG. 11, procedure 1003 can comprise process 1101 of providing to the user one or more electricity transfer credits. The electricity transfer credits can be similar or identical to the electricity transfer credits described above with respect to ETSN 100 (FIG. 1).

Procedure 1003 can also comprise process 1102 of providing to the user one or more electricity transfer coupons. The electricity transfer coupons can be similar or identical to the electricity transfer coupons described above with respect to ETSN 100 (FIG. 1).

Procedure 1003 can further comprise process 1103 of providing to the user one or more third-party coupons. The third-party coupons can be similar or identical to the third-party coupons described above with respect to ETSN 100 (FIG. 1).

Procedure 1003 can still further comprise process 1104 of making usage data corresponding to the user available to the user. The usage data can be similar or identical to the usage data described above with respect to ETSN 100 (FIG. 1).

Procedure 1003 can additionally comprise process 1105 of providing to the user access to one or more user electronic forums permitting the user to communicate with one or more other users of the ETSN. The electronic forums can be similar or identical to the electronic forums described above with respect to ETSN 100 (FIG. 1).

Procedure 1003 can also comprise process 1106 of notifying the user of one or more events permitting the user to communicate with the one or more other users of the ETSN. The events permitting the user to communicate with the other user(s) of the ETSN can be similar or identical to the events permitting the user to communicate with the other user(s) of the ETSN described above with respect to ETSN 100 (FIG. 1).

Procedure 1003 can further comprise process 1107 of notifying the user of one or more events providing one or more opportunities for discounted and/or free use of the electricity transfer system. The events providing one or more opportunities for discounted and/or free use of the ETSN can be similar or identical to the events providing one or more opportunities for discounted and/or free use of the ETSN described above with respect to ETSN 100 (FIG. 1).

Returning to FIG. 10, method 1000 can also comprise procedure 1004 of accepting a reservation request from the user to use the electricity transfer system in the basic member user capacity and/or the premium member user capacity. Performing procedure 1004 can be similar to accepting the reservation request from the user to use the electricity transfer system in the basic member user capacity and/or the premium member capacity as described above with respect to ETSN 100 (FIG. 1). In some embodiments, procedure 1004 can be omitted. In further embodiments, procedure 1004 can be repeated one or more times.

Method 100 can comprise procedure 1005 of providing a map to the user. The map can be similar or identical to the map described above with respect to ETSN 100 (FIG. 1). For example, the map can be configured to indicate a location of the electricity transfer system. Further, the map can be configured to indicate (a) an availability of the electricity transfer system, (b) a cost of using the electricity transfer system, (c) a type of the electricity transfer system, and/or (d) at least one reference location associated with the electricity transfer system. In some embodiments, procedure 1005 can be omitted. In further embodiments, procedure 1005 can be repeated one or more times.

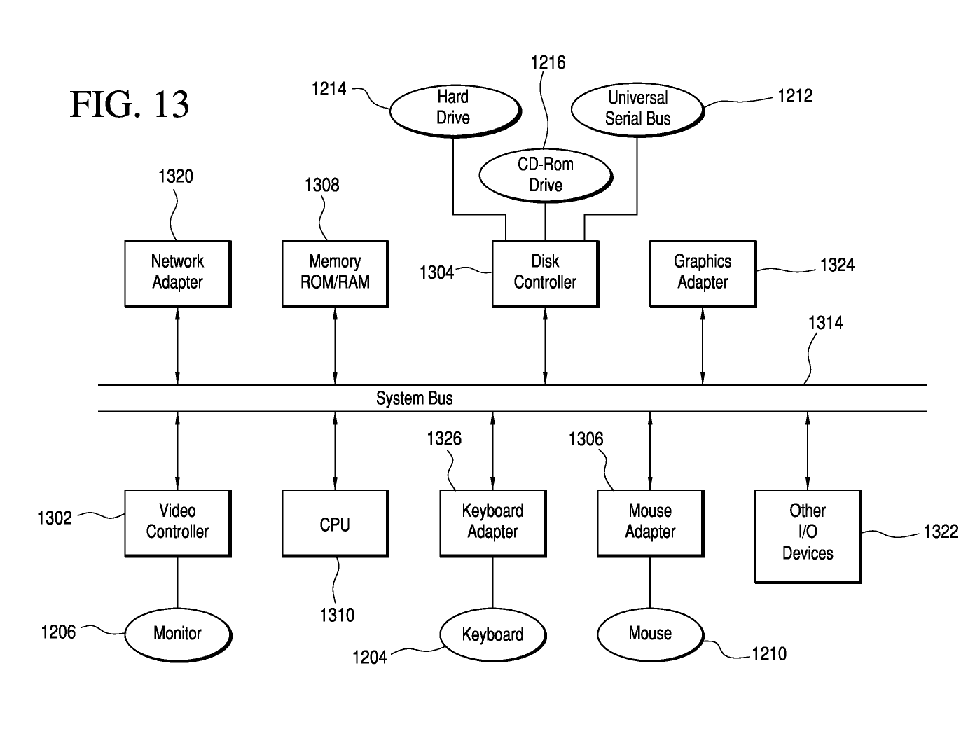

Turning ahead again in the drawings, FIG. 12 illustrates an exemplary embodiment of computer system 1200, all of which or a portion of which can be suitable for implementing an embodiment of ETSN computer system 102 (FIG. 1), ETS computer system 111 (FIG. 1), and/or any of various other elements of ETSN 100 (FIG. 1) as well as any of the various procedures, processes, and/or activities of method 200 (FIG. 2), method 500 (FIG. 5), method 800 (FIG. 8), and/or method 1000 (FIG. 10). As an example, a different or separate one of chassis 1202 (and its internal components) can be suitable for implementing ETSN computer system 102 (FIG. 1), ETS computer system 111 (FIG. 1), etc. Furthermore, one or more elements of computer system 1200 (e.g., refreshing monitor 1206, keyboard 1204, and/or mouse 1210, etc.) can also be appropriate for implementing ETSN computer system 102 (FIG. 1). Computer system 1200 comprises chassis 1202 containing one or more circuit boards (not shown), Universal Serial Bus (USB) port 1212, Compact Disc Read-Only Memory (CD-ROM) and/or Digital Video Disc (DVD) drive 1216, and hard drive 1214. A representative block diagram of the elements included on the circuit boards inside chassis 1202 is shown in FIG. 13. Central processing unit (CPU) 1310 in FIG. 13 is coupled to system bus 1314 in FIG. 13. In various embodiments, the architecture of CPU 1310 can be compliant with any of a variety of commercially distributed architecture families.

Continuing with FIG. 13, system bus 1314 also is coupled to memory storage unit 1308, where memory storage unit 1308 comprises both read only memory (ROM) and random access memory (RAM). Non-volatile portions of memory storage unit 1308 or the ROM can be encoded with a boot code sequence suitable for restoring computer system 1200 (FIG. 12) to a functional state after a system reset. In addition, memory storage unit 1308 can comprise microcode such as a Basic Input-Output System (BIOS). In some examples, the one or more memory storage units of the various embodiments disclosed herein can comprise memory storage unit 1308, a USB-equipped electronic device, such as, an external memory storage unit (not shown) coupled to universal serial bus (USB) port 1212 (FIGS. 12-13), hard drive 1214 (FIGS. 12-13), and/or CD-ROM or DVD drive 1216 (FIGS. 12-13). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 1310.

In the depicted embodiment of FIG. 13, various I/O devices such as disk controller 1304, graphics adapter 1324, video controller 1302, keyboard adapter 1326, mouse adapter 1306, network adapter 1320, and other I/O devices 1322 can be coupled to system bus 1314. Keyboard adapter 1326 and mouse adapter 1306 are coupled to keyboard 1204 (FIGS. 12-13) and mouse 1210 (FIGS. 12-13), respectively, of computer system 1200 (FIG. 12). While graphics adapter 1324 and video controller 1302 are indicated as distinct units in FIG. 13, video controller 1302 can be integrated into graphics adapter 1324, or vice versa in other embodiments. Video controller 1302 is suitable for refreshing monitor 1206 (FIGS. 12-13) to display images on a screen 1208 (FIG. 12) of computer system 1200 (FIG. 12). Disk controller 1304 can control hard drive 1214 (FIGS. 12-13), USB port 1212 (FIGS. 12-13), and CD-ROM drive 1216 (FIGS. 12-13). In other embodiments, distinct units can be used to control each of these devices separately.

In some embodiments, network adapter 1320 can comprise and/or be implemented as a WNIC (wireless network interface controller) card (not shown) plugged or coupled to an expansion port (not shown) in computer system 1200 (FIG. 12). In other embodiments, the WNIC card can be a wireless network card built into computer system 1200 (FIG. 12). A wireless network adapter can be built into computer system 1200 by having wireless communication capabilities integrated into the motherboard chipset (not shown), or implemented via one or more dedicated wireless communication chips (not shown), connected through a PCI (peripheral component interconnector) or a PCI express bus of computer system 1200 (FIG. 12) or USB port 1212 (FIG. 12). In other embodiments, network adapter 1320 can comprise and/or be implemented as a wired network interface controller card (not shown). Accordingly, communication module 106 (FIG. 1) can comprise a network adapter similar or identical to network adapter 1320.

Although many other components of computer system 1200 (FIG. 12) are not shown, such components and their interconnection are well known to those of ordinary skill in the art. Accordingly, further details concerning the construction and composition of computer system 1200 and the circuit boards inside chassis 1202 (FIG. 12) are not discussed herein.

When computer system 1200 in FIG. 12 is running, program instructions stored on a USB-equipped electronic device connected to USB port 1212, on a CD-ROM or DVD in CD-ROM and/or DVD drive 1216, on hard drive 1214, or in memory storage unit 1308 (FIG. 13) are executed by CPU 1310 (FIG. 13). A portion of the program instructions, stored on these devices, can be suitable for carrying out at least part of ETSN 100 (FIG. 1) as well as any of the various procedures, processes, and/or activities of method 200 (FIG. 2), method 500 (FIG. 5), method 800 (FIG. 8), and/or method 1000 (FIG. 10).

Although computer system 1200 is illustrated as a desktop computer in FIG. 12, there can be examples where computer system 1200 may take a different form factor while still having functional elements similar to those described for computer system 1200. In some embodiments, computer system 1200 may comprise a single computer, a single server, or a cluster or collection of computers or servers, or a cloud of computers or servers. Typically, a cluster or collection of servers can be used when the demand on computer system 1200 exceeds the reasonable capability of a single server or computer. In many embodiments, ETSN computer system 102 (FIG. 1) can comprise a single server, or a cluster or collection of computers or servers, or a cloud of computers or servers.

Meanwhile, in some embodiments, ETSN computer system 102 (FIG. 1) and/or ETS computer system 111 (FIG. 1) can have only those processing capabilities and/or memory storage capabilities as are reasonably necessary to perform the functionality, described above with respect to ETSN 100 (FIG. 1). In a more detailed example, ETS computer system 111 could be implemented as a microcontroller comprising flash memory, or the like. Reducing the sophistication and/or complexity of any of ETSN computer system 102 (FIG. 1) and/or ETS computer system 111 (FIG. 1) can reduce the size and/or cost of implementing ETS 100 (FIG. 1). Nonetheless, in other embodiments, any of ETSN computer system 102 (FIG. 1) and/or ETS computer system 111 (FIG. 1) may need additional sophistication and/or complexity to operate as desired.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 201-206 of FIG. 2, processes 301-302 of FIG. 3, processes 401-403 of FIG. 4, procedures 501-511 of FIG. 5, processes 601-602 of FIG. 6, processes 701-704 of FIG. 7, procedures 801-804 of FIG. 8, processes 901-906 of FIG. 9, procedures 1001-1005 of FIG. 10, and/or processes 1101-1107 may be comprised of many different procedures, processes, and activities and be performed by many different modules, in many different orders, that any element of FIGS. 1-13 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) An electricity transfer system network configured to be operated by an electricity transfer system network operator, the electricity transfer system network comprising:
multiple electricity transfer systems;
wherein:
the electricity transfer system network is configured such that the user is able to use each of the multiple electricity transfer systems in two or more user capacities;
the electricity transfer system network operator bills the user for the user's use of the multiple electricity transfer systems according to two or more payment schemes;
the two or more user capacities comprise at least two of a guest user capacity, a first-tier member user capacity, a second-tier member user capacity, or a free user capacity;
the two or more payment schemes comprise at least two of a pay-per-transaction payment scheme, a pay-per-period payment scheme, or a non-payment payment scheme;
when the user uses the multiple electricity transfer systems in the guest user capacity, the electricity transfer system network operator is paid by the user according to the pay-per-transaction payment scheme;
when the user uses the multiple electricity transfer systems in either of the first-tier member capacity or the second-tier member capacity, the electricity transfer system network operator is paid by the user according to the pay-per-period payment scheme; and
when the user uses the multiple electricity transfer systems in the free user capacity, the electricity transfer system operator is paid by the user according to the non-payment payment scheme.

2) The electricity transfer system network of claim 1 wherein:
the electricity transfer system network operator administrates the electricity transfer system network with at least one of an electricity transfer system network computer system or an application programmable interface.

3) The electricity transfer system network of claim 1 wherein:
under the pay-per-transaction payment scheme, the user receives a one-time activation code for a single use of one of the multiple electricity transfer systems after authorizing the electricity transfer system network operator to bill the user on a one-off basis.

4) The electricity transfer system network of claim 1 wherein:
under the pay-per-period payment scheme, the user provides authorization to the electricity transfer system network operator to regularly bill a revolving account of the user for uses of the multiple electricity transfer systems by the user during a predetermined period of time.

5) The electricity transfer system network of claim 4 wherein:
under the pay-per-period payment scheme, the user further provides authorization to the electricity transfer system network operator to bill the revolving account of the user for the uses of the multiple electricity transfer systems by the user in an event that an aggregate cost of the uses of the multiple electricity transfer systems by the user equals or exceeds a predetermined cost.

6) The electricity transfer system network of claim 4 wherein:
the predetermined period of time comprises a month.

7) The electricity transfer system network of claim 1 further comprising:
an authentication mechanism provided by the electricity transfer system network operator;
wherein:
the multiple electricity transfer systems are configured to authenticate an identity of the user via the authentication mechanism when the user uses the multiple electricity transfer systems in either of the first-tier member capacity or the second-tier member capacity.

8) The electricity transfer system network of claim 1 wherein:
the electricity transfer system network operator bills the user for taxes associated with using the multiple electricity transfer systems as part of the two or more payment schemes.

9) A method of operating at least one of an electricity transfer system network computer system of an electricity transfer system network or an application programmable interface, at least part of the method being implemented via execution of computer instructions configured to run at one or more processing modules and configured to be stored at one or more memory storage modules of at least one of the electricity transfer system network computer system or one or more cloud computers, the method comprising:
executing one or more first computer instructions configured to communicate with an electricity transfer system of electricity transfer systems affiliated with the electricity transfer system network to permit a user of the electricity transfer system network to use the electricity transfer system to transfer electricity from the electricity transfer system to a rechargeable energy storage system of an electric vehicle of the user;
executing one or more second computer instructions configured to receive a signal from the electricity transfer system indicating that the user is using the electricity transfer system in one of two or more user capacities, the two or more user capacities comprising at least two of a guest user capacity, a first-tier member user capacity, or a second-tier member user capacity;
executing one or more third computer instructions configured to bill the user for using the electricity transfer system according to a pay-per-transaction payment scheme if the user uses the electricity transfer system in the guest user capacity; and
executing one or more fourth computer instructions configured to bill the user for using the electricity transfer system according to a pay-per-period payment scheme if the user uses the electricity transfer system in either of the first-tier member user capacity or the second-tier member user capacity,
wherein the computer instructions comprise the one or more first, second, third, and fourth computer instructions.

10) The method of claim 9 wherein:
the at least two of the guest user capacity, the first-tier member user capacity, or the second-tier member user capacity further comprises at least three of the guest user capacity, the first-tier member user capacity, the second-tier member user capacity, or a free user capacity; and
the method further comprises executing one or more fifth computer instructions configured to bill the user for using the electricity transfer system according to a non-payment payment scheme if the user uses the electricity transfer system in the free user capacity.

11) The method of claim 9 wherein:
executing the one or more third computer instructions comprises executing one or more fifth computer instructions configured to provide a one-time activation code to the user for a single use of the electricity transfer system after receiving authorization from the user to bill the user on a one-off basis.

12) The method of claim 9 wherein:
executing the one or more fourth computer instructions comprises executing one or more fifth computer instructions configured to bill a revolving account of the user (a) for use of the electricity transfer system by the user upon completion of a predetermined period of time, (b) for other uses of the electricity transfer system by the user during the predetermined period of time, and (c) for use of other ones of the electricity transfer systems of the electricity transfer system network during the predetermined period of time.

13) The method of claim 12 wherein:
executing the one or more fourth computer instructions further comprises executing one or more sixth computer instructions configured to bill the revolving account of the user in the event that the user owes more than a predetermined quantity of money within the predetermined period of time.

14) The method of claim 9 further comprising:
executing one or more fifth computer instructions configured to authenticate an identity of the user via an authentication mechanism after executing the one or more second computer instructions.

15) The method of claim 9 wherein:
executing the one or more third computer instructions comprises executing one or more fifth computer instructions configured to bill the user for taxes associated with using the electricity transfer system integrally with the pay-per-transaction payment scheme if the user uses the electricity transfer system in the guest user capacity; and
executing the one or more fourth computer instructions comprises executing one or more sixth computer instructions configured to bill the user for the taxes associated with using the electricity transfer system integrally with the pay-per-period payment scheme if the user uses the electricity transfer system in the either of the first-tier member user capacity or the second-tier member user capacity.

16) An electricity transfer system network configured to be operated by an electricity transfer system network operator, the electricity transfer system network comprising:
an electricity transfer system configured to permit a user of the electricity transfer system network to use the electricity transfer system to transfer electricity from the electricity transfer system to a rechargeable energy storage system of an electric vehicle of the user;
wherein:
the electricity transfer system network is organized such that the user is able to use the electricity transfer system in two or more user capacities;
the electricity transfer system network operator bills the user for use of the electricity transfer system according to two or more user fee structures corresponding to the two or more user capacities respectively;
the two or more user capacities comprise at least two of a guest user capacity, a first-tier member user capacity, a second-tier member user capacity, or a free user capacity; and
the two or more user fee structures comprise at least two of a guest user fee structure, a first-tier member user fee structure, a second-tier member user fee structure, or a free user fee structure.

17) The electricity transfer system network of claim 16 wherein:
the electricity transfer system network operator administrates the electricity transfer system network with at least one of an electricity transfer system network computer system or an application programmable interface.

18) The electricity transfer system network of claim 16 wherein:
the electricity transfer system network operator establishes the two or more user capacities; and
at least one of the electricity transfer system network operator or a host of the electricity transfer system establishes the two or more user fee structures.

19) The electricity transfer system network of claim 16 wherein:
for a particular transaction where the user uses the electricity transfer system:
a first cost to the user if billed according to the second-tier member user fee structure is less than a second cost to the user if billed according to the first-tier member user fee structure; and
the second cost to the user is less than a third cost to the user if billed according to the guest user fee structure.

20) The electricity transfer system network of claim 16 wherein:
the electricity transfer system network operator receives a membership fee from the user in order for the user to be able to use the electricity transfer system in at least one of the first-tier member user capacity or the second-tier member user capacity.

21) The electricity transfer system network of claim 20 wherein:
the membership fee comprises at least one of an upfront membership fee or an annual membership fee.

22) The electricity transfer system network of claim 16 further comprising:
an other electricity transfer system configured to permit the user of the electricity transfer system network to use the other electricity transfer system to transfer electricity from the other electricity transfer system to the rechargeable energy storage system of the electric vehicle of the user;
wherein:
the electricity transfer system network is organized such that the user is able to use the other electricity transfer system in the two or more user capacities;
the electricity transfer system network operator bills the user for use of the other electricity transfer system according to two or more other user fee structures corresponding to the two or more user capacities respectively;
the two or more other user fee structures comprise at least two of an other guest user fee structure, an other first-tier member user fee structure, an other second-tier member user fee structure, or the free user fee structure; and
each of the guest user fee structure, the first-tier member user fee structure, and the second-tier member user fee structure differ from the other guest user fee structure, the other first-tier member user fee structure, and the other second-tier member user fee structure, respectively, according to at least one of: (a) at least one regional factor or (b) at least one host preference.

23) The electricity transfer system network of claim 16 wherein:
the electricity transfer system comprises at least one of extended charge electric vehicle supply equipment or fast charge electric vehicle supply equipment;
wherein:
when the electricity transfer system comprises the extended charge electric vehicle supply equipment, the guest user fee structure comprises an extended charge guest user fee structure, the first-tier member user fee structure comprises an extended charge first-tier member user fee structure, and the second-tier member user fee structure comprises an extended charge second-tier member user fee structure; and
when the electricity transfer system comprises the fast charge electric vehicle supply equipment, the guest user fee structure comprises a fast charge guest user fee structure that is different from the extended charge guest user fee structure, the first-tier member user fee structure comprises a fast charge first-tier member user fee structure that is different from the extended charge first-tier member user fee structure, and the second-tier member user fee structure comprises a fast charge second-tier member user fee structure that is different from the extended charge second-tier member user fee structure.

24) A method of operating at least one of an electricity transfer system network computer system of an electricity transfer system network or an application programmable interface, at least part of the method being implemented via execution of computer instructions configured to run at one or more processing modules and configured to be stored at one or more memory storage modules of at least one of the electricity transfer system network computer system or one or more cloud computers, the method comprising:
executing one or more first computer instructions configured to communicate with an electricity transfer system configured to permit a user of the electricity transfer system network to use the electricity transfer system to transfer electricity from the electricity transfer system to a rechargeable energy storage system of an electric vehicle of the user;
executing one or more second computer instructions configured to receive a signal from the electricity transfer system indicating that the user is using the electricity transfer system in one of two or more user capacities, the two or more user capacities comprising at least two of a guest user capacity, a first-tier member user capacity, or a second-tier member user capacity; and
executing one or more third computer instructions configured to bill the user for use of the electricity transfer system according to one of two or more user fee structures corresponding to the two or more user capacities, respectively, the two or more user fee structures comprise at least two of a guest user fee structure, a first-tier member user fee structure, or a second-tier member user fee structure,
wherein the computer instructions comprise the one or more first, second, and third computer instructions, and the electricity transfer system network comprises the electricity transfer system.

25) The method of claim 24 wherein:
the at least two of the guest user capacity, the first-tier member user capacity, or the second-tier member user capacity further comprises at least three of the guest user capacity, the first-tier member user capacity, the second-tier member user capacity, or a free user capacity; and
the at least two of the guest user fee structure, the first-tier member user fee structure, or the second-tier member user fee structure further comprises at least two of the guest user fee structure, the first-tier member user fee structure, or the second-tier member user fee structure, or a free user fee structure.

26) The method of claim 24 further comprising:
establishing the two or more user capacities; and
one of:
establishing the two or more user fee structures;
agreeing on the two or more user fee structures with the host; or
receiving the two or more user fee structures from the host.

27) The method of claim 24 wherein:
executing the one or more third computer instructions comprises one of:
executing one or more fourth computer instructions configured to bill the user a first amount of money if the user uses the electricity transfer system in the second-tier member user capacity;
executing one or more fifth computer instructions configured to bill the user a second amount of money if the user uses the electricity transfer system in the first-tier member user capacity, the second amount of money being greater than the first amount of money; or
executing one or more sixth computer instructions configured to bill the user a third amount of money if the user uses the electricity transfer system in the guest user capacity, the third amount of money being greater than the second amount of money.

28) The method of claim 24 further comprising:
executing one or more fourth computer instructions configured to receive a membership fee from the user in order for the user to be able to use the electricity transfer system in at least one of the first-tier member user capacity or the second-tier member user capacity.

29) The method of claim 28 wherein:
executing the one or more fourth computer instructions comprises executing one or more fifth computer instructions configured to receive at least one of an upfront membership fee or an annual membership fee.

30) The method of claim 24 further comprising:
executing one or more fourth computer instructions configured to communicate with an other electricity transfer system configured to permit the user of the electricity transfer system network to use the other electricity transfer system to transfer electricity from the other electricity transfer system to the rechargeable energy storage system of the electric vehicle of the user;
executing one or more fifth computer instructions configured to receive an other signal from the electricity transfer system indicating that the user is using the other electricity transfer system in one of the two or more user capacities; and
executing one or more sixth computer instructions configured to bill the user for use of the other electricity transfer system according to one of two or more other user fee structures corresponding to the two or more user capacities, respectively, the two or more other user fee structures comprising at least two of an other guest user fee structure, an other first-tier member user fee structure, or an other second-tier member user fee structure, and each of the guest user fee structure, the first-tier member user fee structure, and the second-tier member user fee structure differing from the other guest user fee structure, the other first-tier member user fee structure, and the other second-tier member user fee structure, respectively, according to at least one of: (a) at least one regional factor or (b) at least one host preference.

31) The method of claim 24 wherein:
executing the one or more first computer instructions comprises executing one or more fourth computer instructions configured to communicate with at least one of an extended charge electric vehicle supply equipment or a fast charge electric vehicle supply equipment, the electricity transfer system comprising the at least one of the extended charge electric vehicle supply equipment or the fast charge electric vehicle supply equipment;
when the electricity transfer system comprises the extended charge electric vehicle supply equipment, executing the one or more second computer instructions comprises executing one or more fifth computer instructions configured to receive a second request from the electricity transfer system indicating that the user is using the electricity transfer system in one of: (a) an extended charge guest user capacity of the guest user capacity, (b) an extended charge first-tier member user capacity of the first-tier member user capacity, or (c) an extended charge second-tier member user capacity of the second-tier member user capacity; and
when the electricity transfer system comprises the fast charge electric vehicle supply equipment, executing the one or more second computer instructions comprises executing one or more sixth computer instructions configured to receive a third request from the electricity transfer system indicating that the user is using the electricity transfer system in one of: (a) a fast charge guest user capacity of the guest user capacity that is different from the extended charge guest user capacity, (b) a fast charge first-tier member user capacity of the first-tier member user capacity that is different from the extended charge first-tier member user capacity, or (c) a fast charge second-tier member user capacity of the second-tier member user capacity that is different from the extended charge second-tier member user capacity.

32) An electricity transfer system network configured to be operated by an electricity transfer system network operator, the electricity transfer system network comprising:
an electricity transfer system of a host;
wherein:
the electricity transfer system is configured to permit a user of the electricity transfer system network to use the electricity transfer system to transfer electricity from the electricity transfer system to a rechargeable energy storage system of an electric vehicle of the user;
the host is affiliated with the electricity transfer system network and is separate from the electric transfer system network operator;
the electricity transfer system network is organized such that the user is able to use the electricity transfer system in two or more user capacities;
the two or more user capacities comprise at least two of a guest user capacity, a first-tier member user capacity, or a second-tier member user capacity; and
the electricity transfer system network operator provides one or more host incentives to the host in exchange for being affiliated with the electricity transfer system network.

33) The electricity transfer system network of claim 32 wherein:
the electricity transfer system network operator administrates the electricity transfer system network with at least one of an electricity transfer system network computer system or an application programmable interface.

34) The electricity transfer system network of claim 32 wherein:
at least one of the electricity transfer system network operator or the host establishes operation time parameters of the electricity transfer system.

35) The electricity transfer system network of claim 32 wherein:
the two or more user capacities further comprise at least one of a fleet user capacity or a free user capacity.

36) The electricity transfer system network of claim 32 wherein:
the one or more host incentives comprise revenue sharing by the electricity transfer system network operator with at least the host.

37) The electricity transfer system network of claim 32 wherein:
the electricity transfer system is configured so that the electricity transfer system network operator is able to present third-party data to the user;
the third-party data comprises host advertisement data; and
the one or more host incentives comprise the host advertisement data provided to the user.

38) The electricity transfer system network of claim 32 wherein:
the electricity transfer system is configured so that the electricity transfer system network operator is able to present third-party data to the user;
the host is able to select at least some of the third-party data presented to the user; and
the one or more host incentives comprise the host being able to select the at least some of the third-party data presented to the user.

39) The electricity transfer system network of claim 32 wherein:
the one or more host incentives comprise at least one of (a) one or more host coupons provided to the user, (b) one or more programs encouraging dialogue between the user and the host, or (c) access to usage data corresponding to the user.

40) A method of operating at least one of an electricity transfer system network computer system of an electricity transfer system network or an application programmable interface, at least part of the method being implemented via execution of computer instructions configured to run at one or more processing modules and configured to be stored at one or more memory storage modules of at least one of the electricity transfer system network computer system or one or more cloud computers, the method comprising:
executing one or more first computer instructions configured to communicate with an electricity transfer system of a host, the electricity transfer system being configured to permit a user of the electricity transfer system network to use the electricity transfer system to transfer electricity from the electricity transfer system to a rechargeable energy storage system of an electric vehicle of the user, and the host being affiliated with the electricity transfer system network;
executing one or more second computer instructions configured to receive a signal from the electricity transfer system indicating that the user is using the electricity transfer system in one of two or more user capacities, the two or more user capacities comprising at least two of a guest user capacity, a first-tier member user capacity, or a second-tier member user capacity; and
executing one or more third computer instructions configured to incentivize the host to affiliate with the electricity transfer system network,
wherein the computer instructions comprise the one or more first, second, and third computer instructions.

41) The method of claim 40 wherein:
executing the one or more third computer instructions comprises executing one or more fourth computer instructions configured to provide operation time parameters of the electricity transfer system to the electricity transfer system, the operation time parameters being established by at least one of an electricity transfer system network operator or the host.

42) The method of claim 40 wherein:
executing the one or more third computer instructions comprises executing the one or more second computer instructions, where the two or more user capacities further comprise at least one of a fleet user capacity or a free user capacity.

43) The method of claim 40 wherein:
executing the one or more third computer instructions comprises executing one or more fourth computer instructions configured to share at least part of the revenue of the electricity transfer system network with at least the host.

44) The method of claim 40 further comprising:
executing one or more fourth computer instructions configured to present third-party data to the user, the third-party data comprising host advertisement data,
wherein executing the one or more third computer instructions comprises executing the one or more fourth computer instructions.

45) The method of claim 40 further comprising:
executing one or more fourth computer instructions configured to present third-party data to the user,
wherein executing the one or more third computer instructions comprises executing one or more fifth computer instructions configured to receive a selection by the host of at least some of the third-party data to be presented to the user.

46) The method of claim 40 wherein:
executing the one or more third computer instructions comprises at least one of: (a) executing one or more fourth computer instructions configured to provide one or more host coupons provided to the user, (b) executing one or more fifth computer instructions configured to notify the user of one or more programs encouraging a commercial transaction between the user and the host, or (c) executing one or more sixth computer instructions configured to make usage data corresponding to the user available to the host.

47) An electricity transfer system network configured to be operated by an electricity transfer system network operator, the electricity transfer system network comprising:
an electricity transfer system configured to permit a user of the electricity transfer system network to use the electricity transfer system to transfer electricity from the electricity transfer system to a rechargeable energy storage system of an electric vehicle of the user;
wherein:
the electricity transfer system network is organized such that the user is able to use the electricity transfer system in two or more user capacities;
the two or more user capacities comprise at least two of a guest user capacity, a first-tier member user capacity, or a second-tier member user capacity; and
the electricity transfer system network operator provides one or more member incentives to the user in exchange for using the electricity transfer system in at least one of the first-tier member user capacity or the second-tier member user capacity.

48) The electricity transfer system network of claim 47 wherein:
the electricity transfer system network operator administrates the electricity transfer system network with at least one of an electricity transfer system network computer system or an application programmable interface.

49) The electricity transfer system network of claim 47 wherein:
the electricity transfer system is configured to be reserved for future use; and
the one or more member incentives comprise the electricity transfer system network operator permitting the user to reserve the electricity transfer system for the future use.

50) The electricity transfer system network of claim 47 wherein:
the one or more member incentives comprise at least one of (a) one or more electricity transfer credits, (b) one or more electricity transfer coupons, (c) one or more third-party coupons, or (d) access to usage data corresponding to the user.

51) The electricity transfer system network of claim 47 wherein:
the one or more member incentives comprise at least one of (a) access to one or more user electronic forums permitting the user to communicate with one or more other users of the electricity transfer system network or (b) access to one or more events permitting the user to communicate with the one or more other users of the electricity transfer system network.

52) The electricity transfer system network of claim 47 wherein:
the one or more member incentives comprise access to one or more events providing one or more opportunities for discounted or free use of the electricity transfer system to the user.

53) The electricity transfer system network of claim 47 wherein:
the one or more member incentives comprise access to a map being configured to indicate a location of the electricity transfer system and at least one of an availability of the electricity transfer system, a cost of using the electricity transfer system, a type of the electricity transfer system, or at least one reference location associated with the electricity transfer system.

54) A method of operating at least one of an electricity transfer system network computer system of an electricity transfer system network or an application programmable interface, at least part of the method being implemented via execution of computer instructions configured to run at one or more processing modules and configured to be stored at one or more memory storage modules of at least one of the electricity transfer system network computer system or one or more cloud computers, the method comprising:
executing one or more first computer instructions configured to communicate with an electricity transfer system of a host, the electricity transfer system being configured to permit a user of the electricity transfer system network to use the electricity transfer system to transfer electricity from the electricity transfer system to a rechargeable energy storage system of an electric vehicle of the user and the host being affiliated with the electricity transfer system network;
executing one or more second computer instructions configured to receive a request from the electricity transfer system indicating that the user is using the electricity transfer system in one of two or more user capacities, the two or more user capacities comprising at least two of a guest user capacity, a first-tier member user capacity, or a second-tier member user capacity; and
executing one or more third computer instructions configured to incentivize the user to use the electricity transfer system in at least one of the first-tier member capacity or the second-tier member capacity,
wherein the computer instructions comprise the one or more first, second, and third computer instructions.

55) The method of claim 54 further comprising:
executing one or more fourth computer instructions configured to accept a reservation request from the user to use the electricity transfer system in at least one of the first-tier member user capacity or the second-tier member capacity,
wherein executing the one or more third computer instructions comprises executing the one or more fourth computer instructions.

56) The method of claim 54 wherein:
executing the one or more third computer instructions comprises at least one of:
(a) executing one or more fourth computer instructions configured to provide to the user one or more electricity transfer credits, (b) executing one or more fifth computer instructions configured to provide to the user one or more electricity transfer coupons, (c) executing one or more sixth computer instructions configured to provide to the user one or more third-party coupons, or (d) executing one or more seventh computer instructions configured to make usage data corresponding to the user available to the user.

57) The method of claim 54 wherein:
executing the one or more third computer instructions comprises at least one of:
(a) executing one or more fourth computer instructions configured to provide to the user access to one or more user electronic forums permitting the user to communicate with one or more other users of the electricity transfer system network or (b) executing one or more fifth computer instructions configured to notify the user of one or more events permitting the user to communicate with the one or more other users of the electricity transfer system network.

58) The method of claim 54 wherein:
executing the one or more third computer instructions comprises executing one or more fourth computer instructions configured to notify the user of one or more events providing one or more opportunities for discounted or free use of the electricity transfer system.

59) The method of claim 54 wherein:
executing the one or more third computer instructions comprises executing one or more fourth computer instructions configured to provide a map to the user, the map being configured to indicate a location of the electricity transfer system and at least one of an availability of the electricity transfer system, a cost of using the electricity transfer system, a type of the electricity transfer system, or at least one reference location associated with the electricity transfer system.
